(19) United States
(12) Patent Application Publication
(10) Pub. No.: US 2022/0253207 A1
(43) Pub. Date: Aug. 11, 2022

(54) DISPLAY METHOD AND ELECTRONIC DEVICE

(71) Applicant: HUAWEI TECHNOLOGIES CO., LTD., Shenzhen (CN)

(72) Inventors: Simon EKSTRAND, Lund (SE); Xiaokang SUN, Lund (SE); Xueyan HUANG, Shenzhen (CN)

(21) Appl. No.: 17/730,566

(22) Filed: Apr. 27, 2022

Related U.S. Application Data
(63) Continuation of application No. PCT/CN2021/072717, filed on Jan. 19, 2021.

(30) Foreign Application Priority Data
Jan. 19, 2020 (CN) 202010061204.1

(51) Int. Cl. G06F 3/04847; G06F 3/0481; H04M 1/72409

(52) U.S. Cl. CPC G06F 3/04847; G06F 3/04886; H04M 1/72409; G06F 3/0481

(57) ABSTRACT

This application provides a display method and an electronic device. The electronic device includes a display screen, and the method includes: The electronic device detects a first operation performed by a user on the display screen, and displays, in response to the first operation, a first display interface on the display screen, where the first display interface includes one or a plurality of task cards and a control panel, and the one or each of the plurality of task cards corresponds to an application. The solutions in embodiments of this application help the user quickly start the control panel, thereby improving user experience when the user uses the electronic device.

### CROSS-REFERENCE TO RELATED APPLICATIONS

This application is a continuation of International Application No. PCT/CN2021/072717, filed on Jan. 19, 2021, which claims priority to Chinese Patent Application No. 202010061204.1, filed on Jan. 19, 2020. The disclosures of the aforementioned applications are hereby incorporated by reference in their entireties.

### TECHNICAL FIELD

This application relates to the terminal field, and more specifically, to a display method and an electronic device.

### BACKGROUND

A control panel is a system-level application on mobile terminals such as a mobile phone and a tablet, and is used to provide a mobile phone user with shortcut operations such as setting and enabling/disabling a system function. A mobile phone control panel is one of applications frequently used by a terminal user. The user often performs a shortcut operation through the control panel. A smart home product can also be controlled on the control panel.

A control panel of a new mobile phone developed by the Apple Inc. after 2017 (for example, the iPhone X and the iPhone XS) is evoked by pulling down from the top right of the mobile phone. A control panel of each Android mobile phone is pulled down from the top of the mobile phone and integrated with a notification center. The control panel is above a message notification list. The control panel can be slid to the bottom of the mobile phone for full-screen display, and the control panel can be slid to the middle of the mobile phone and stays on this position.

Currently, as a screen of the mobile phone is increasingly larger, a manner of pulling the control plane down from the top of the mobile phone is not conducive to a one-handed operation of starting the control panel performed by the user.

### SUMMARY

This application provides a display method and an electronic device, to help a user quickly start a control panel, thereby improving user experience when the user uses the electronic device.

According to a first aspect, a display method is provided. The method is applied to an electronic device, the electronic device includes a display screen, and the method includes: The electronic device detects a first operation performed by a user on the display screen, and displays, in response to the first operation, a first display interface on the display screen, where the first display interface includes one or a plurality of task cards and a control panel, and the one or each of the plurality of task cards corresponds to an application.

In an embodiment of the application, an entry to the plurality of task cards and an entry to the control panel are integrated. When the user invokes the plurality of task cards, the control panel may be simultaneously displayed on the display screen. This helps the user quickly invoke the control panel when the user holds the electronic device with one hand, thereby helping improve user experience.

In an embodiment, the control panel includes a control used to control a common function of the smart device. The common function is a basic function of the smart device, for example, a network connection function, or a function that has impact on the one or the plurality of task cards. In an embodiment, the control panel may alternatively be considered as a drop-down menu or a pull-up menu of the electronic device. The pull-down menu or the pull-up menu may be described in the background, or may be further improved. In an embodiment, the entry is added to the drop-down menu or the pull-up menu, thereby improving user operation flexibility.

In an embodiment, the first operation is an operation of invoking a display interface of the plurality of task cards performed by the user.

With reference to the first aspect, in an embodiment of the first aspect, the control panel includes switch controls or adjustment bars of parameter values that are of one or more smart devices, and/or redirection entries to one or more applications.

In an embodiment of the application, the switch controls or the adjustment bars of the parameter values that are of the smart devices, or the redirection entries to the applications may be added to the control panel, so that after invoking the control panel, the user can directly start a smart device and adjust a parameter value of the smart device, or start an application. In this way, redundant operations of searching for the application and performing a related operation in the application that are performed by the user are reduced, and user experience is improved.

With reference to the first aspect, in an embodiment of the first aspect, a first area of the control panel includes a switch control of a first smart device; the one or more smart devices include the first smart device; and the method further includes: The electronic device detects a second operation performed by the user in the first area, where the first area includes the switch control of the first smart device. The electronic device displays, in response to the second operation, an adjustment bar of a first parameter value of the first smart device in the first area.

In an embodiment of the application, the control panel may include the switch control of the smart device. After performing the second operation on the switch control, the user may display the adjustment bar of the parameter value at a position at which the switch control is originally displayed, and adjust the corresponding function parameter value while ensuring that the hand does not leave the screen. In this way, the redundant operations of searching for the application and performing the related operation in the application that are performed by the user are reduced, and user experience is improved.

With reference to the first aspect, in an embodiment of the first aspect, a first area of the control panel includes a switch control of a first smart device; the one or more smart devices include the first smart device; and the method further includes: The electronic device detects a second operation performed by the user in the first area, where the first area includes the switch control of the first smart device. The electronic device displays, in response to the second operation, an adjustment bar of a first parameter value of the first smart device on the entire control panel, or displays an adjustment bar of a first parameter value on the entire display screen.

In an embodiment of the application, the control panel may include the switch control of the smart device. After performing the second operation on the switch control, the user may display the adjustment bar of the parameter value on the entire control screen or the entire display screen, and adjust the corresponding function parameter value while ensuring that the hand does not leave the screen. In this way, the redundant operations of searching for the application and performing the related operation in the application that are performed by the user are reduced, and user experience is improved.

With reference to the first aspect, in an embodiment of the first aspect, a second area of the control panel includes a redirection entry to a first application; the one or more applications include the first application; and the method further includes: The electronic device detects a third operation performed by the user in the second area. The electronic device displays, in response to the third operation, a display interface of the first application on the display screen.

In an embodiment of the application, the control panel includes the redirection entry to the application. When the user wants to quickly start an application, the user may directly enter the application by using a redirection entry on the control panel. In this way, the redundant operations of searching for the application and performing the related operation in the application that are performed by the user are reduced, and user experience is improved.

With reference to the first aspect, in an embodiment of the first aspect, a third area of the control panel includes first information, and the first information is a switch control of a second smart device, an adjustment bar of a second parameter value of a second smart device, or a redirection entry to a second application; a fourth area of the control panel includes second information, and the second information is a switch control of a third smart device, an adjustment bar of a third parameter value of a third smart device, or a redirection entry to a third application; a display area of the third area is greater than a display area of the fourth area, the one or more smart devices include the second smart device and the third smart device, and the one or more applications include the second application and the third application; and the method further includes: automatically displaying the second information in the third area and displaying the first information in the fourth area when it is detected within preset time that a frequency at which the user uses the second information is greater than a frequency at which the user uses the first information.

In an embodiment of the application, the electronic device may automatically adjust display positions of the switch controls, the adjustment bars of the parameter values, and the redirection entries to the applications on the control panel. The electronic device may also display, in a large display area, a switch control, an adjustment bar of a parameter value, or a redirection entry to an application that is used by the user with a relatively high frequency within the preset duration, so that the user can quickly find corresponding information after invoking the control panel. In this way, the redundant operations of searching for the application and performing the related operation in the application that are performed by the user are reduced, and user experience is improved.

In an embodiment of the first aspect, the first display interface displays a first task card and the control panel, and the first task card corresponds to an application started before the electronic device detects the first operation.

According to a second aspect, this application provides an electronic device, including a flexible display screen, one or more sensors, one or more processors, one or more memories, and one or more computer programs. The processors are coupled to the sensors, the flexible display screen, and the memories. The one or more computer programs are stored in the memories. When the electronic device runs, the processors execute the one or more computer programs stored in the memories, to enable the electronic device to perform the display method according to the first aspect.

According to a third aspect, this application provides a computer storage medium, including computer instructions. When the computer instructions are run on an electronic device, the electronic device is enabled to perform the display method according to the first aspect.

According to a fourth aspect, this application provides a computer program product. When the computer program product runs on an electronic device, the electronic device is enabled to perform the display method according to the first aspect.

It may be understood that, the electronic device in the second aspect, the computer storage medium in the third aspect, and the computer program product in the fourth aspect that are provided above are all configured to perform the corresponding method provided above. Therefore, for beneficial effects that can be achieved by the electronic device, the computer storage medium, and the computer program product, refer to beneficial effects in the corresponding method provided above. Details are not described again herein.

### BRIEF DESCRIPTION OF DRAWINGS

FIG. 1 is a schematic structural diagram of an electronic device according to an embodiment of this application;

FIG. 2 is a schematic architectural diagram of an operating system in an electronic device according to an embodiment of this application;

FIG. 3(a) to FIG. 3(d) are a schematic diagram 1 of a scenario of a display method for an electronic device according to an embodiment of this application;

FIG. 4(a) to FIG. 4(c) are a schematic diagram 2 of a scenario of a display method for an electronic device according to an embodiment of this application;

FIG. 5(a) and FIG. 5(b) are a schematic diagram 3 of a scenario of a display method for an electronic device according to an embodiment of this application;

FIG. 6(a) and FIG. 6(b) are a schematic diagram 4 of a scenario of a display method for an electronic device according to an embodiment of this application;

FIG. 7(a) to FIG. 7(f) are a schematic diagram 5 of a scenario of a display method for an electronic device according to an embodiment of this application;

FIG. 8(a) to FIG. 8(e) are a schematic diagram 6 of a scenario of a display method for an electronic device according to an embodiment of this application;

FIG. 9(a) to FIG. 9(d) are a schematic diagram 7 of a scenario of a display method for an electronic device according to an embodiment of this application;

FIG. 10(a) to FIG. 10(d) are a schematic diagram 8 of a scenario of a display method for an electronic device according to an embodiment of this application;

FIG. 11(a) to FIG. 11(c) are a schematic diagram 9 of a scenario of a display method for an electronic device according to an embodiment of this application;

FIG. 12(a) and FIG. 12(b) are a schematic diagram 10 of a scenario of a display method for an electronic device according to an embodiment of this application;

FIG. 13 is a schematic flowchart of a display method for an electronic device according to an embodiment of this application; and

FIG. 14 is a schematic block diagram of an electronic device according to an embodiment of this application.

### DESCRIPTION OF EMBODIMENTS

Terms used in the following embodiments are merely intended to describe embodiments, but are not intended to limit this application. Terms “one”, “a”, “the”, “the foregoing”, “this”, and “the one” of singular forms used in this specification and the appended claims of this application are also intended to include plural forms like “one or more”, unless otherwise specified in the context clearly. It should be further understood that in the following embodiments of this application, “at least one” and “one or more” refer to one, two, or more than two. The term “and/or” is used to describe an association relationship between associated objects and indicates that three relationships may exist. For example, A and/or B may indicate the following three cases: Only A exists, both A and B exist, and only B exists, where A and B may be singular or plural. The character “/” generally indicates an “or” relationship between the associated objects.

Reference to “an embodiment”, “some embodiments”, or the like described in this specification indicates that one or more embodiments of this application include a feature, structure, or characteristic described with reference to embodiments. Therefore, in this specification, statements, such as “in an embodiment”, “in some embodiments”, “in some other embodiments”, and “in other embodiments”, that appear at different places do not necessarily mean referring to a same embodiment. Instead, the statements mean “one or more but not all of embodiments”, unless otherwise emphasized in other ways. The terms “include”, “comprise”, “have”, and variants of the terms all mean “include but are not limited to”, unless otherwise emphasized in other ways.

The following describes an electronic device, a user interface used for the electronic device, and embodiments used for using the electronic device. In some embodiments, the electronic device may be a portable electronic device that further includes other functions such as a personal digital assistant function and/or a music player function, for example, a mobile phone, a tablet computer, or a wearable electronic device having a wireless communication function (for example, a smartwatch). An example embodiment of the portable electronic device includes but is not limited to a portable electronic device using iOS®, Android®, Microsoft®, or another operating system. The portable electronic device may alternatively be another portable electronic device, for example, a laptop. It should be further understood that, in some other embodiments, the foregoing electronic device may not be the portable electronic device but a desktop computer.

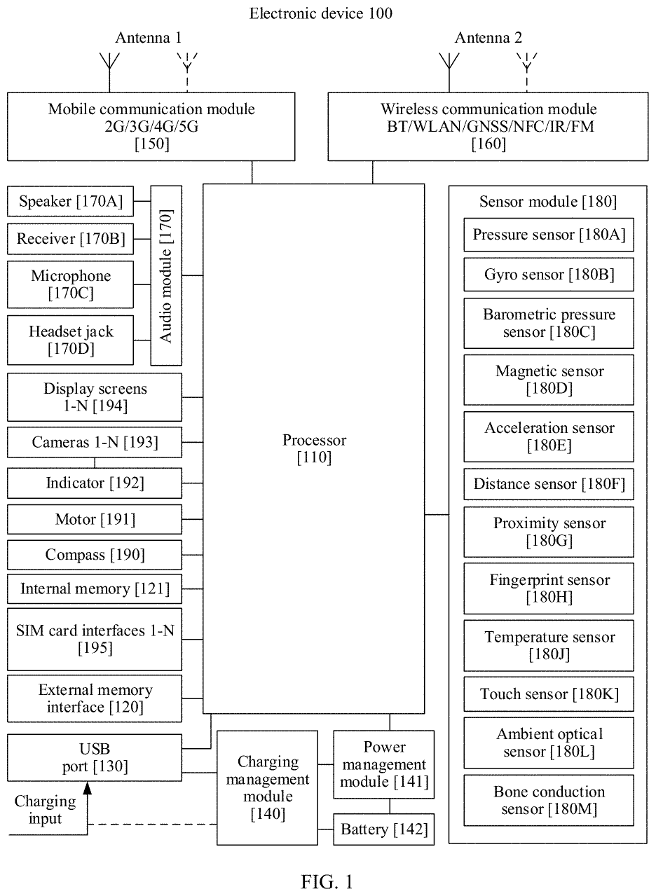

For example, FIG. 1 is a schematic diagram of a structure of an electronic device 100. The electronic device 100 may include a processor 110, an external memory interface 120, an internal memory 121, a universal serial bus (USB) port 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a compass 190, a motor 191, an indicator 192, cameras 1-N 193, display screens 194, subscriber identification module (SIM) card interfaces 1-N 195, and the like.

It may be understood that an example structure in an embodiment of the application does not constitute a limitation on the electronic device 100. In other embodiments of this application, the electronic device 100 may include more or fewer components than those shown in the figure, combine some components, split some components, or have different component arrangements. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be independent components, or may be integrated into one or more processors. In some embodiments, the electronic device 100 may alternatively include one or more processors 110. The controller may generate an operation control signal based on instruction operation code and a time sequence signal, to complete control of instruction reading and instruction execution. In some other embodiments, a memory may be further disposed in the processor 110, and is configured to store instructions and data. For example, the memory in the processor 110 may be a cache memory. The memory may store instructions or data just used or cyclically used by the processor 110. If the processor 110 needs to use the instructions or the data again, the processor 110 may directly invoke the instructions or the data from the memory. In this way, repeated access is avoided, a waiting time of the processor 110 is reduced, and efficiency of processing data or executing instructions by the electronic device 100 is improved.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, the SIM interface, the USB interface, and/or the like. The USB interface 130 is an interface that conforms to a USB standard specification, and may be a mini USB interface, a micro USB interface, a USB Type-C interface, or the like. The USB interface 130 may be configured to connect to a charger to charge the electronic device 100, or may be configured to transmit data between the electronic device 100 and a peripheral device. The USB interface 130 may alternatively be configured to connect to a headset, and play audio by using the headset.

It may be understood that an interface connection relationship between the modules illustrated in an embodiment of the application is merely an example for description, and does not constitute a limitation on the structure of the electronic device 100. In other embodiments of this application, the electronic device 100 may alternatively use an interface connection mode different from that in the foregoing embodiment, or use a combination of a plurality of interface connection modes.

A wireless communication function of the electronic device 100 may be implemented by using the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the electronic device 100 may be configured to cover one or more communication bands. Different antennas may be further multiplexed, to increase antenna utilization. For example, the antenna 1 may be multiplexed as a diversity antenna in a wireless local area network. In other embodiments, the antenna may be used in combination with a tuning switch.

The electronic device 100 implements a display function by using the GPU, the display screen 194, the application processor, and the like. The GPU is a microprocessor for image processing, and is connected to the display screen 194 and the application processor. The GPU is configured to perform mathematical and geometric calculation, and render an image. The processor 110 may include one or more GPUs that execute program instructions to generate or change display information.

The display screen 194 is configured to display an image, a video, and the like. The display screen 194 includes a display panel. The display panel may use a liquid crystal display (liquid crystal display, LCD), an organic light-emitting diode (OLED), an active-matrix organic light-emitting diode (AMOLED), a flexible light-emitting diode (FLED), Mini LED, Micro LED, Micro OLED, a quantum dot light-emitting diode (QLED), or the like. In some embodiments, the electronic device 100 may include one or more display screens 194.

In some embodiments of this application, when the display panel uses a material, for example, the OLED, the AMOLED, or the FLED, the display screen 194 in FIG. 1 may be bent. Herein, that the display screen 194 may be bent means that the display screen may be bent to any angle at any part, and may be held at the angle. For example, the display screen 194 may be folded left and right from the middle. Alternatively, the display screen 194 may be folded up and down from the middle.

The display screen 194 of the electronic device 100 may be a flexible display screen. Currently, the flexible display screen attracts much attention due to unique features and huge potential of the flexible display screen. Compared with a conventional screen, the flexible display screen has features of strong flexibility and bendability, and can provide a user with a new interaction mode based on the feature of bendability, to meet more requirements of the user for an electronic device. For an electronic device configured with a foldable display screen, the foldable display screen on the electronic device may be switched between a small screen in a folded form and a large screen in an expanded form at any time. Therefore, the user uses a split-screen function more frequently on the electronic device configured with the foldable display screen.

The electronic device 100 can implement a photographing function by using the ISP, the camera 193, the video codec, the GPU, the display screen 194, the application processor, and the like.

The NPU is a neural-network (NN) computing processor, quickly processes input information by referring to a structure of a biological neural network, for example, by referring to a mode of transmission between human brain neurons, and may further continuously perform self-learning. Applications such as intelligent cognition, for example, image recognition, facial recognition, speech recognition, and text understanding, of the electronic device 100 may be implemented by using the NPU.

The external memory interface 120 may be configured to connect to an external memory card, for example, a micro SD card, to extend a storage capability of the electronic device 100. The external storage card communicates with the processor 110 through the external memory interface 120, to implement a data storage function. For example, files such as music and a video are stored in the external storage card.

The internal memory 121 may be configured to store one or more computer programs, and the one or more computer programs include instructions. The processor 110 may run the instructions stored in the internal memory 121, so that the electronic device 100 performs the display method provided in some embodiments of this application, various applications, data processing, and the like. The internal memory 121 may include a program storage area and a data storage area. The program storage area may store an operating system. The program storage area may further store one or more applications (such as Gallery and Contacts), and the like. The data storage area may store data (for example, a photo and a contact) created during use of the electronic device 100, and the like. In addition, the internal memory 121 may include a high-speed random access memory, or may include a nonvolatile memory, for example, one or more magnetic disk storage devices, a flash memory device, or a universal flash storage (UFS). In some embodiments, the processor 110 may run the instructions stored in the internal memory 121 and/or the instructions stored in the memory that is disposed in the processor 110, to enable the electronic device 100 to perform the display method provided in embodiments of this application, other applications, and data processing. The electronic device 100 can implement an audio function, for example, a music playing function and a recording function, by using the audio module 170, the speaker 170A, the receiver 170B, the microphone 170C, the headset jack 170D, the application processor, and the like.

The sensor module 180 may include a pressure sensor 180A, a gyro sensor 180B, a barometric pressure sensor 180C, a magnetic sensor 180D, an acceleration sensor 180E, a distance sensor 180F, a proximity sensor 180G, a fingerprint sensor 180H, a temperature sensor 180J, a touch sensor 180K, an ambient optical sensor 180L, a bone conduction sensor 180M, and the like.

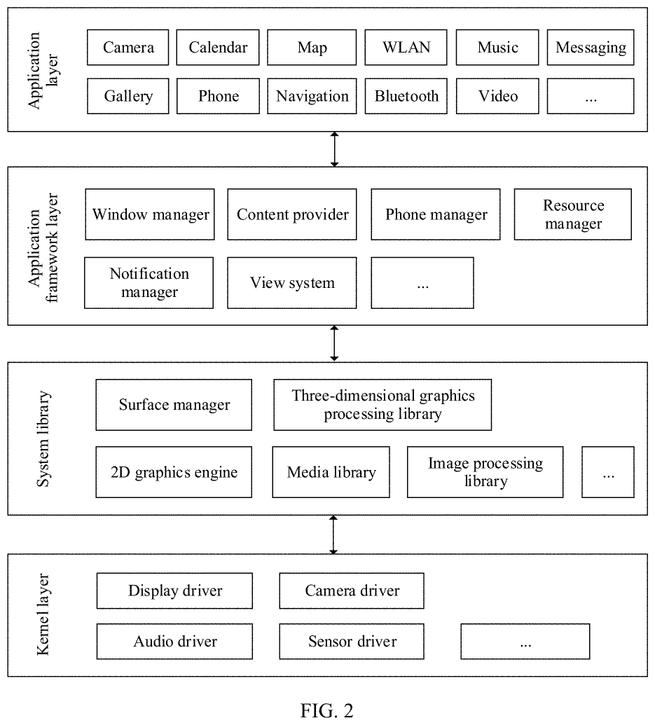

FIG. 2 is a block diagram of a software structure of the electronic device 100 according to an embodiment of the application. In a hierarchical architecture, software is divided into several layers, and each layer has a clear role and task. The layers communicate with each other through a software interface. In some embodiments, an Android system is divided into four layers: an application layer, an application framework layer, an Android runtime (Android runtime) and a system library, and a kernel layer from top to bottom. The application layer may include a series of application packages.

As shown in FIG. 2, the application package may include applications such as Camera, Gallery, Calendar, Phone, Map, Navigation, WLAN, Bluetooth, Music, Video, and Messaging.

The application framework layer provides an application programming interface (API) and a programming framework for an application at the application layer. The application framework layer includes some predefined functions.

As shown in FIG. 2, the application framework layer may include a window manager, a content provider, a view system, a phone manager, a resource manager, a notification manager, and the like.

The window manager is configured to manage a window program. The window manager may obtain a size of a display screen, determine whether there is a status bar, perform screen locking, take a screenshot, and the like.

The content provider is configured to store and obtain data, and enable the data to be accessed by an application. The data may include a video, an image, audio, calls that are made and received, a browsing history and a browsing bookmark, an address book, and the like.

The view system includes visual controls such as a control for displaying a text and a control for displaying a picture. The view system may be configured to construct an application. A display interface may include one or more views. For example, a display interface including an SMS message notification icon may include a text display view and a picture display view.

The phone manager is configured to provide a communication function of the electronic device 100, for example, management of a call status (including answering, declining, or the like).

The resource manager provides various resources for an application such as a localized character string, an icon, a picture, a layout file, and a video file.

The notification manager enables an application to display notification information in the status bar, and may be configured to convey a notification message. The notification manager may automatically disappear after a short pause without requiring user interaction. For example, the notification manager is configured to notify download completion, provide a message notification, and the like. The notification manager may alternatively be a notification that appears in a top status bar of the system in a form of a graph or a scroll bar text, for example, a notification of an application running on the background or a notification that appears on a screen in a form of a dialog window. For example, text information is prompted in the status bar, a prompt tone is produced, the electronic device vibrates, or an indicator light blinks.

The Android runtime and the system library may include a plurality of function modules such as a surface manager, a media library, a three-dimensional graphics processing library (for example, OpenGL ES), and a 2D graphics engine (for example, SGL).

The surface manager is configured to manage a display subsystem and provide fusion of 2D and 3D layers for a plurality of applications.

The media library supports playback and recording in a plurality of commonly used audio and video formats, static image files, and the like. The media library may support a plurality of audio and video coding formats such as MPEG4, H.264, MP3, AAC, AMR, JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

For ease of understanding, a mobile phone having the structures shown in FIG. 1 and FIG. 2 is used as an example in the following embodiments of this application, and the display method provided in embodiments of this application is described with reference to the accompanying drawings.

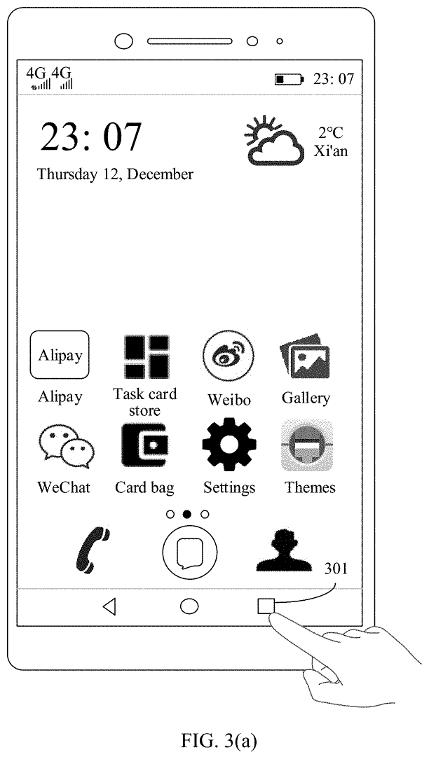

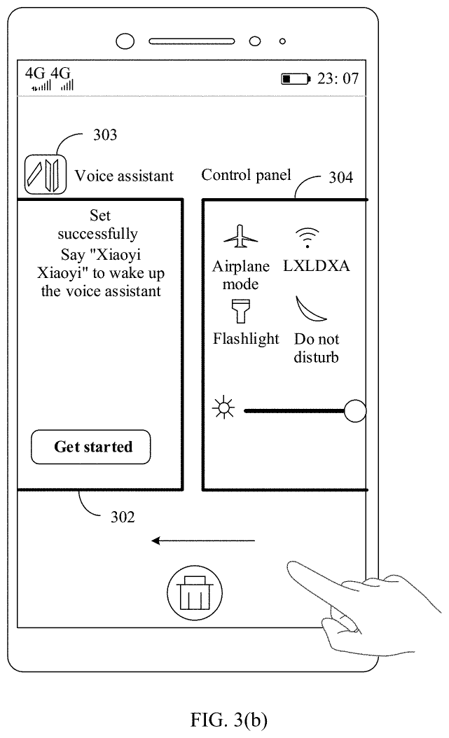

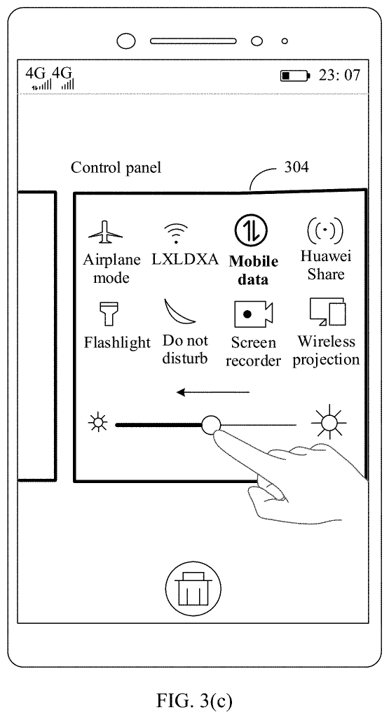

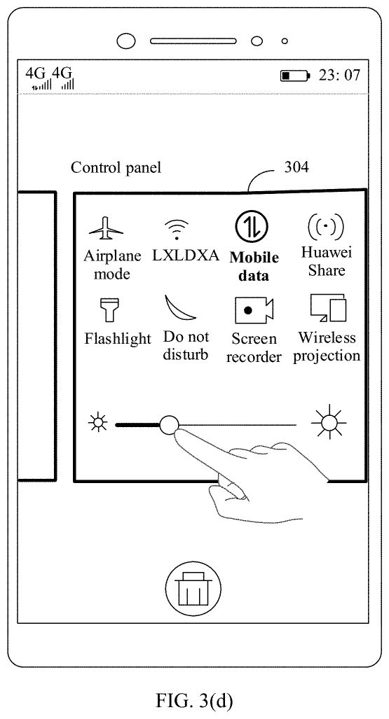

FIG. 3(a) to FIG. 3(d) show a group of graphical user interfaces (graphical user interface, GUI) of the mobile phone. A process in which a user invokes a control panel is shown from FIG. 3(a) to FIG. 3(d).

Refer to FIG. 3(a). The GUI is a desktop of the mobile phone. The desktop of the mobile phone includes three desktop pages, and each of the desktop pages includes icons of one or more applications. A current desktop displayed by the mobile phone is a second desktop page, and the desktop page includes an icon of Alipay, an icon of Task card store, an icon of Weibo, an icon of Gallery, an icon of WeChat, an icon of Card bag, an icon of Settings, and an icon of Themes. The desktop page further includes a control 301. The control 301 is configured to control and invoke a display interface of a plurality of task cards and the control panel. When detecting an operation of tapping the control 301 performed by the user, the mobile phone displays the GUI shown in FIG. 3(b).

Refer to FIG. 3(b). The GUI is the display interface of the plurality of task cards and the control panel of the mobile phone. The plurality of task cards may include thumbnails of one or more applications. The user may slide left or right to select an application or the control panel to be displayed. After detecting an operation of sliding left performed by the user on the display interface of the plurality of task cards and the control panel, the mobile phone may display the GUI shown in FIG. 3(c).

When the mobile phone displays a preview interface of the plurality of task cards and the control panel, a preview interface of a plurality of applications may be arranged horizontally. An area on the left is an area in which the plurality of task cards are applied, and an area on the right is an area of the control panel.

Arrangement in FIG. 3(b) is merely an example, and does not represent an actual arrangement style. For the plurality of task cards and the control panel, the plurality of task cards may be applied on the right and the control panel is on the left. Alternatively, the plurality of task cards are on the top and the control panel is on the bottom. Alternatively, the plurality of task cards are on the bottom and the control panel is on the top.

It should be understood that, in an embodiment of the application, there may be a plurality of entries to the display interface of the plurality of task cards and the control panel. After detecting the operation of tapping the control 301 performed by the user, the mobile phone may display the display interface of the plurality of task cards and the control panel. Alternatively, after detecting an operation of sliding up performed by the user on the lower part of a screen, the mobile phone may also display the display interface of the plurality of task cards and the control panel. Alternatively, after detecting a voice instruction of invoking the plurality of cards and the control panel from the user, the mobile phone may display the display interface of the plurality of task cards and the control panel. For an electronic device having an IOS operating system, the mobile phone may invoke a display interface of a plurality of task cards and a control panel after detecting an operation of double-tapping a Home key performed by the user.

It should be further understood that, as shown in FIG. 3(b), the thumbnails of the applications in the plurality of task cards each may be arranged based on a time at which the user switches the corresponding applications to the background, and a thumbnail of an application last switched to the background by the user may be first displayed. For example, in a task card 302 shown in FIG. 3(b), an application corresponding to the task card 302 is a voice assistant application, and an icon 303 is an icon of the voice assistant application. The display interface may further include the task card 302 and the control panel 304. The user may slide left on the interface to display the control panel 304.

Refer to FIG. 3(c). The GUI is another display interface of the plurality of task cards and the control panel of the mobile phone. The display interface includes a complete display interface of the control panel 304. The control panel includes controls such as an airplane mode control, a Wi-Fi control, a mobile data control, a Huawei Share control, a flashlight control, a do not disturb control, a screen control control, a wireless projection control, and a screen brightness adjustment control.

Refer to FIG. 3(d). The GUI is another display interface of the plurality of task cards and the control panel of the mobile phone. After detecting an operation of adjusting the screen brightness control performed by the user on the interface, the mobile phone may adjust screen brightness. For example, after the mobile phone detects an operation of sliding the control left performed by the user, the screen brightness of the mobile phone may be reduced.

In an embodiment, if the user wants to enable Wi-Fi, the user may directly tap the corresponding Wi-Fi control on the display interface shown in FIG. 3(b). Alternatively, if the user wants to turn on a flashlight, the user may directly tap the flashlight control on the display interface shown in FIG. 3(b).

In an embodiment of the application, an entry to the plurality of task cards and an entry to the control panel are integrated, so that when a function of the plurality of task cards is invoked, an interface of the control panel may be simultaneously displayed on the interface, thereby helping the user quickly start a corresponding operation on the control panel.

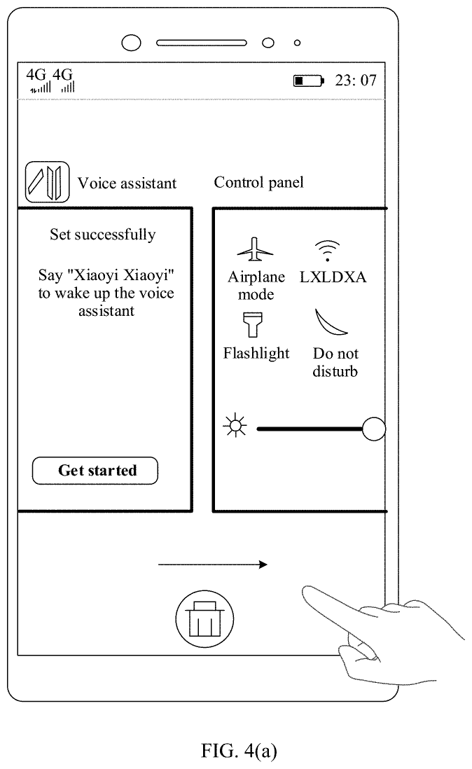

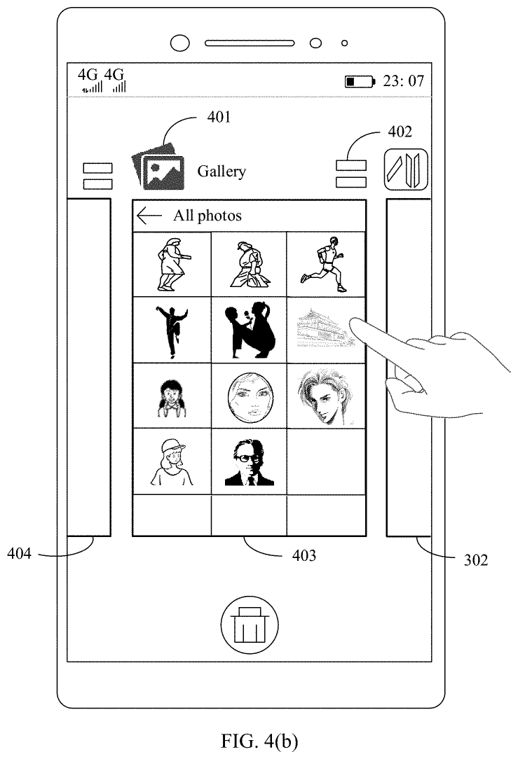

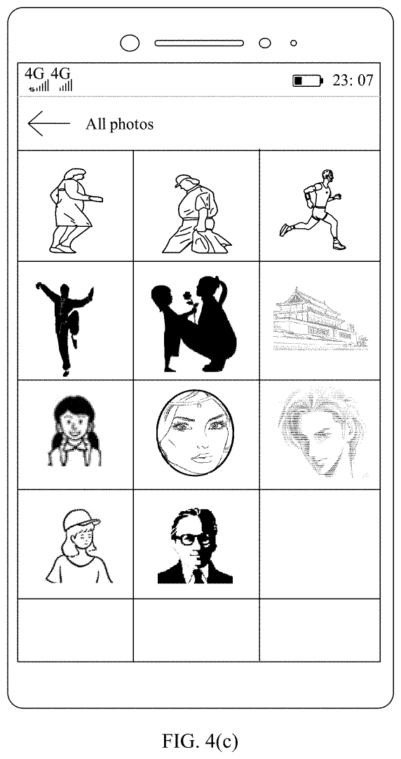

FIG. 4(a) to FIG. 4(c) show another group of GUIs of the mobile phone. FIG. 4(a) to FIG. 4(c) show a process in which the user taps one task card in the plurality of task cards to enter a corresponding application.

Refer to FIG. 4(a). The GUI is another display interface of the plurality of task cards and the control panel of the mobile phone. After detecting an operation of sliding right performed by the user, the mobile phone may display the GUI shown in FIG. 4(b).

Refer to FIG. 4(b). The GUI is another display interface of the plurality of task cards of the mobile phone. The display interface includes a task card 302, a task card 403, and a task card 404. An icon 401 is an icon of the Gallery application corresponding to the task card 403. The display interface further includes a control 402. After detecting an operation of tapping the control 402 performed by the user, the mobile phone may perform a screen splitting operation. For example, the Gallery application is displayed on the upper part of the screen of the mobile phone, and the desktop of the mobile phone is displayed on the lower part of the screen of the mobile phone. After detecting an operation of tapping the task card 403 performed by the user, the mobile phone may display the GUI shown in FIG. 4(c).

Refer to FIG. 4(c). The GUI is a display interface of the Gallery application of the mobile phone.

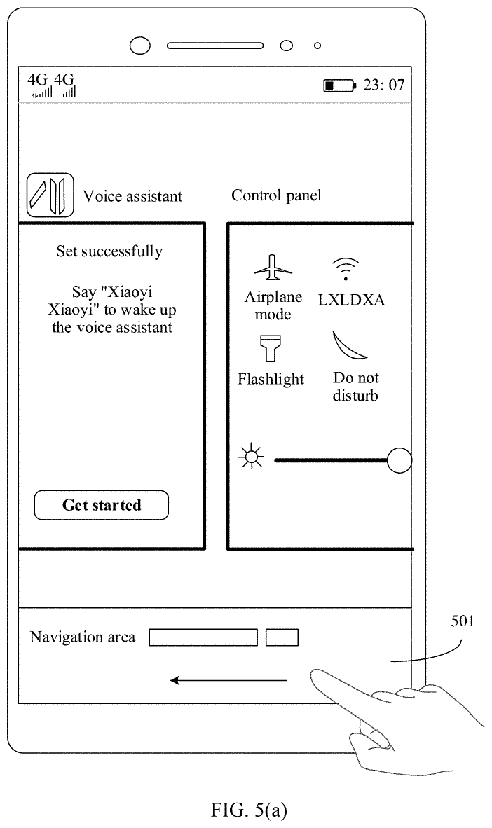

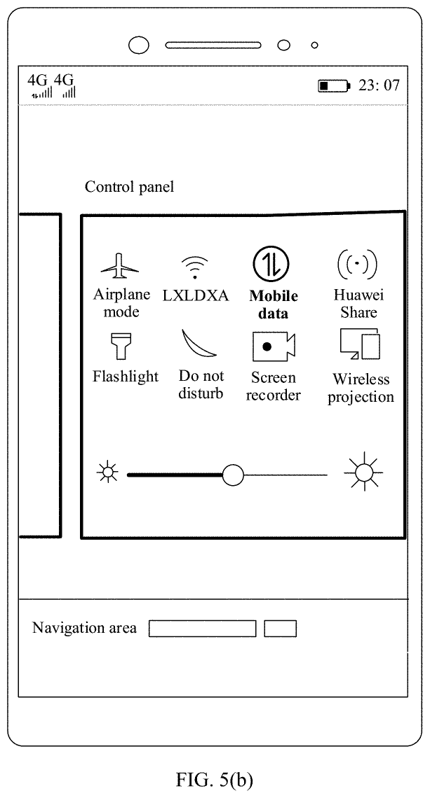

FIG. 5(a) and FIG. 5(b) show another group of GUIs of the mobile phone. Compared with the GUIs shown in FIG. 3(a) to FIG. 3(d), a display interface of the plurality of task cards and the control panel may include a navigation area, and the user may switch between the plurality of task cards and the control panel by using the navigation area.

Refer to FIG. 5(a). The GUI is another display interface of the plurality of task cards and the control panel of the mobile phone. After detecting an operation of sliding left performed by the user in the navigation area of the screen, the mobile phone may display the GUI shown in FIG. 5(b).

Refer to FIG. 5(b). The GUI is another display interface of the plurality of task cards and the control panel of the mobile phone. The mobile phone may display the complete display interface of the control panel. The user may perform a corresponding operation on the complete display interface.

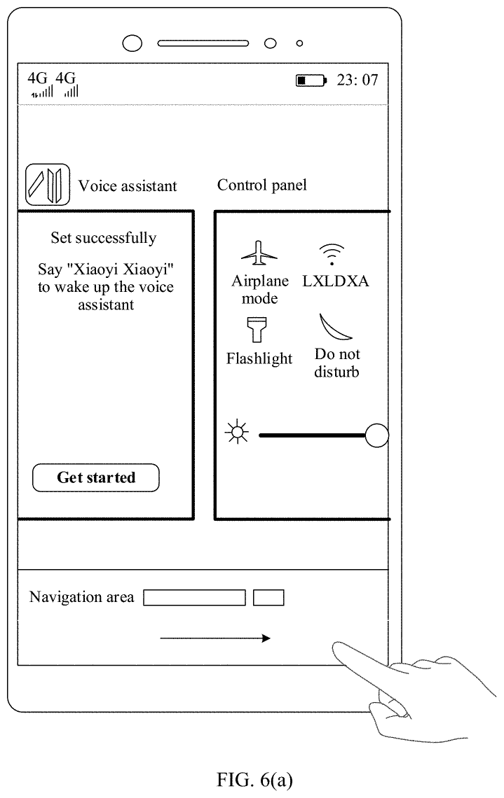

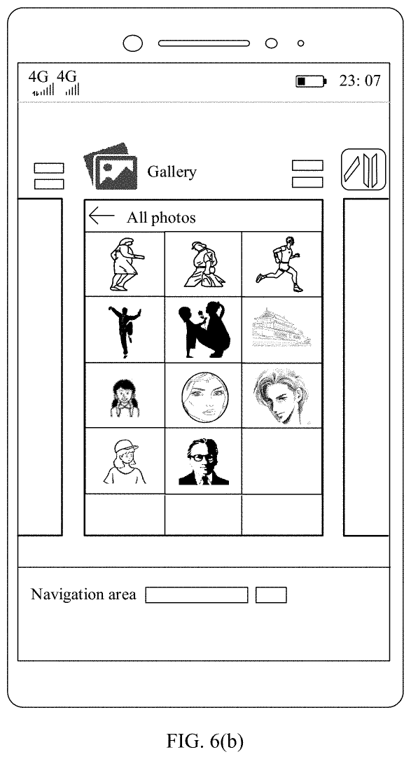

Correspondingly, FIG. 6(a) and FIG. 6(b) show another group of GUIs of the mobile phone.

Refer to FIG. 6(a). The GUI is another display interface of the plurality of task cards and the control panel of the mobile phone. After detecting an operation of sliding right performed by the user in the navigation area of the screen, the mobile phone may display the GUI shown in FIG. 6(b).

Refer to FIG. 6(b). The GUI is another display interface of the plurality of task cards and the control panel of the mobile phone. The mobile phone may display a task card corresponding to the Gallery application.

In an embodiment, after detecting that the user triggers an operation of displaying the display interface of the plurality of task cards and the control panel, the mobile phone may display the complete interface of the control panel and some or all task cards on the desktop of the mobile phone, and the user may view another task card by performing a sliding operation.

The foregoing describes several groups of GUIs provided in embodiments of this application with reference to FIG. 4(a) to FIG. 6(b). The entry to the plurality of task cards and the entry to the control panel are integrated, so that the user may quickly start the control panel, to perform the corresponding operation. In an embodiment of the application, functions on the control panel are not limited to functions shown in FIG. 5(b), and may further include control functions of smart home products such as switch controls and adjustment bars that are of smart devices, such as a bedroom lamp, a bedroom air conditioner, a smart speaker, a living room lamp, an air purifier, a floor sweeping robot, a smart alarm, and a smart desk lamp (for example, the living room lamp has a lamp brightness adjustment bar, the bedroom lamp has a color temperature adjustment bar, and the smart air conditioner has a temperature adjustment bar).

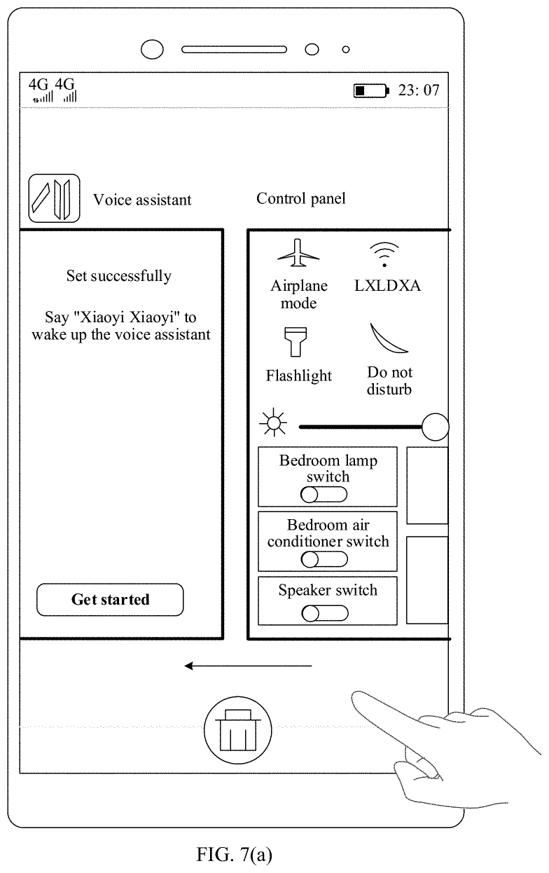

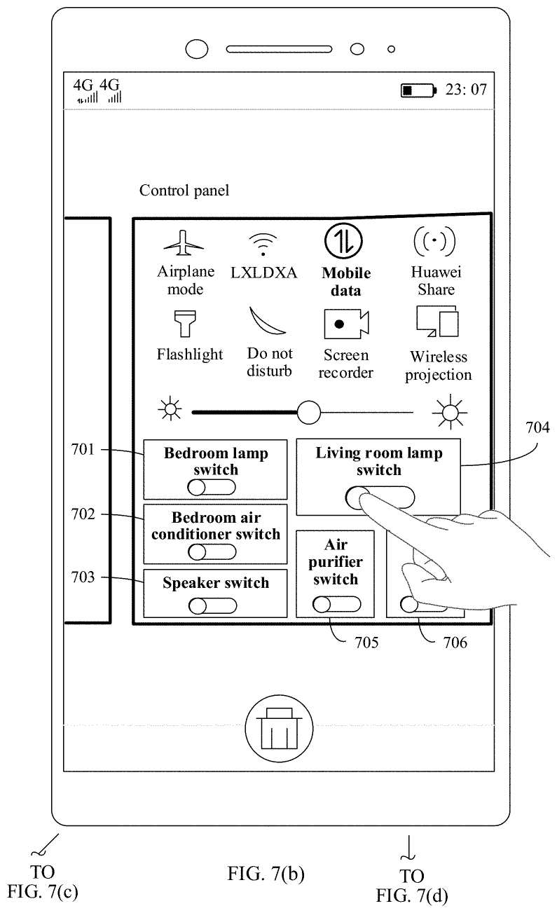

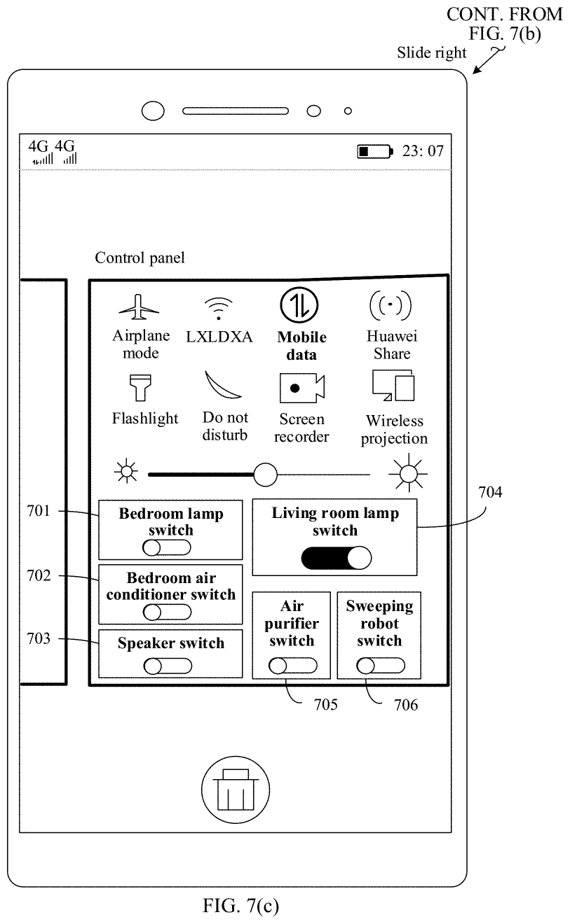

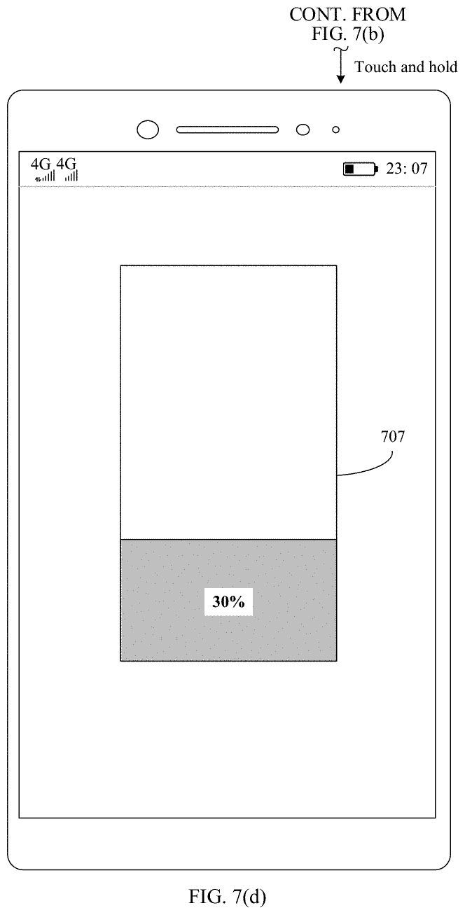

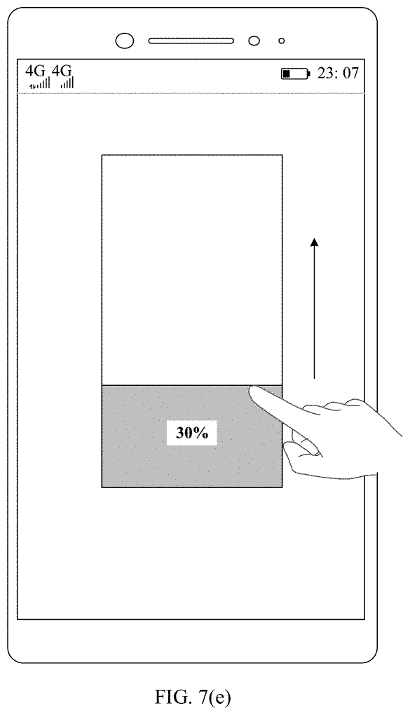

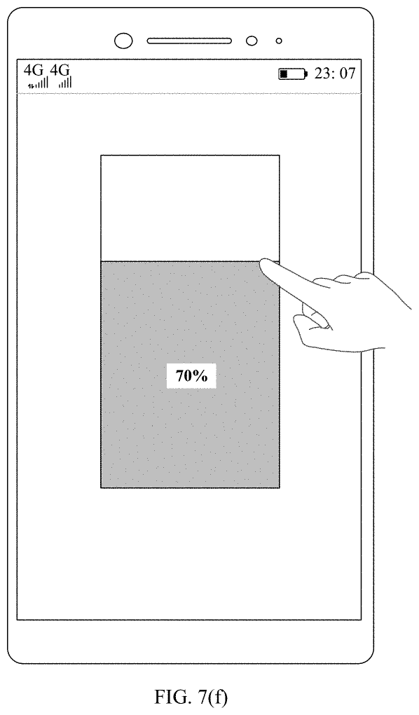

FIG. 7(a) to FIG. 7(f) show another group of GUIs of the mobile phone.

Refer to FIG. 7(a). The GUI is another display interface of the plurality of task cards and the control panel of the mobile phone. After detecting an operation of sliding left performed by the user on the display interface of the plurality of task cards and the control panel, the mobile phone may display the GUI shown in FIG. 7(b).

Refer to FIG. 7(b). The GUI is another display interface of the plurality of task cards and the control panel of the mobile phone. After detecting the operation of sliding left performed by the user on the screen, the mobile phone may display a complete control panel. Compared with the GUI shown in FIG. 3(c), in the GUI shown in FIG. 7(b), a first area 701 on the control panel further includes a bedroom lamp switch control, a second area 702 further includes a bedroom air conditioner switch control, a third area 703 further includes a speaker switch control, a fourth area 704 further includes a living room lamp switch control, a fifth area 705 further includes an air purifier switch control, and a sixth area 706 further includes a floor sweeping robot switch control.

In an embodiment, the first area to the sixth area on the control panel may display the switch controls of the smart devices, or may display the adjustment bars of the smart devices. For example, the bedroom lamp switch control may be displayed in the first area 701, the temperature adjustment bar of the bedroom air conditioner may be displayed in the second area 702, a volume adjustment bar of the speaker may be displayed in the third area 703, the living room lamp switch control may be displayed in the fourth area, and the like.

When detecting that the user slides the living room lamp switch control right, the mobile phone may display the GUI shown in FIG. 7(c). The mobile phone may send an instruction to a cloud server, and the instruction is used to instruct to turn on the living room lamp. After receiving the instruction, the cloud server may send the instruction to the living room lamp. After the instruction is received by the living room lamp, the living room lamp may be turned on.

In addition, brightness of the living room lamp is controlled to a brightness value. For example, the brightness value may be controlled to a brightness value when the living room lamp is turned off last time. Alternatively, the brightness value may be controlled to a preset brightness value.

In an embodiment, if the user wants to turn on the bedroom lamp, the user may directly tap the bedroom lamp switch control on the display interface shown in FIG. 7(b) (or slide the bedroom lamp switch control from left to right). If the user wants to turn on the bedroom air conditioner, the user may also directly tap the bedroom air conditioner switch control on the display interface shown in FIG. 7(b) (or slide the bedroom air conditioner switch control from left to right).

When detecting that the user touches and holds the living room lamp switch control, the mobile phone may display the GUI shown in FIG. 7(d), and the mobile phone may display the brightness adjustment bar of the living room lamp on the entire display screen. Similarly, after detecting that the user touches and holds the living room lamp switch control, the mobile phone may send an instruction to the cloud server, to control the living room lamp to be turned on. The mobile phone may also display the brightness adjustment bar 707 corresponding to the living room lamp.

It should be understood that, in an embodiment of the application, that the mobile phone displays the brightness adjustment bar of the living room lamp on the entire display screen may mean that only the brightness adjustment bar is displayed on the entire display screen in addition to necessary information (for example, a signal, a battery power level, and a time), or may mean that only the brightness adjustment bar is displayed on the entire display screen.

In an embodiment, after detecting an operation of touching and holding the living room lamp switch control performed by the user, the mobile phone may also display the brightness adjustment bar of the living room lamp in an entire display area of the control panel.

Refer to FIG. 7(e). The GUI is a display interface of the brightness adjustment bar of the living room lamp. When detecting an operation of sliding up performed by the user on the brightness adjustment bar, the mobile phone may adjust the brightness value of the living room lamp. For example, the mobile phone may send information about the brightness value to the cloud server. The cloud server sends the information about the brightness value to the living room lamp. Finally, the living room lamp adjusts the brightness value of the lamp based on the information about the brightness value.

Refer to FIG. 7(f). The GUI is another display interface of the brightness adjustment bar of the living room lamp. The user may adjust the brightness value of the living room lamp to 70%, namely, a maximum brightness value.

In an embodiment, after the user touches and holds the living room lamp switch control, the display screen may display the brightness adjustment bar of the living room lamp. In this case, if the mobile phone detects that a finger of the user remains on the screen, the mobile phone may keep displaying the brightness adjustment bar of the living room lamp. When detecting that the finger of the user slides up and down, the mobile phone may adjust the brightness value to increase or decrease. When the mobile phone detects that the finger of the user leaves the screen, the area 704 may display the living room lamp switch control again (in this case, the living room lamp switch control may be turned on).

In an embodiment, after the user touches and holds the living room lamp switch control, the display screen may display the brightness adjustment bar of the living room lamp, and the mobile phone may display the brightness adjustment bar of the living room lamp in the area 704 within preset duration (for example, 10s). In other words, if the finger leaves the screen within the 10s, the brightness adjustment bar will continue to be displayed on the screen. After the preset duration, the mobile phone may display the living room lamp switch control again (in this case, the living room lamp switch control may be turned on).

In an embodiment of the application, the control panel may support control and operations on the smart devices. An operation of touching and holding adjustment bars to directly adjust parameter values is added, so that the user can adjust the adjust parameter values such as brightness, a color temperature, and a temperature before starting smart device applications. The control panel may also have functions of the switch controls and the adjustment bars. Use a smart home scenario as an example. Shortcut operations of a smart lamp at home may be added to the control panel. An operation of turning on or turning off the lamp may be implemented by tapping a control. The control is touched and held, to switch to a level control interface. Brightness of the lamp can be quickly adjusted when a hand slide an adjustment bar up or down without leaving the screen.

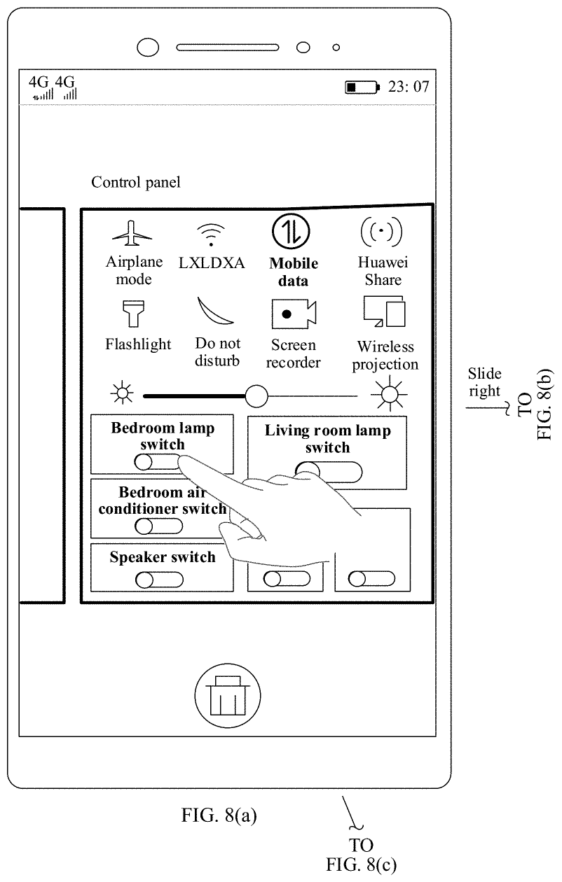

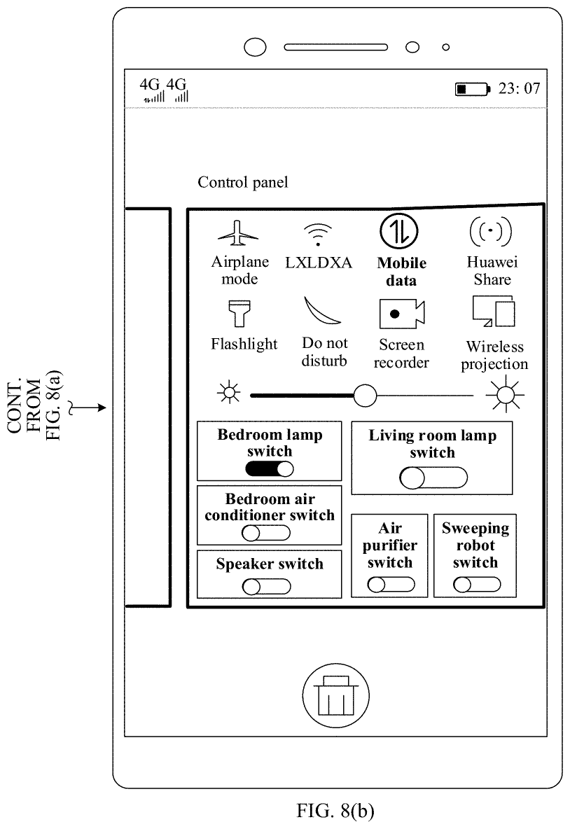

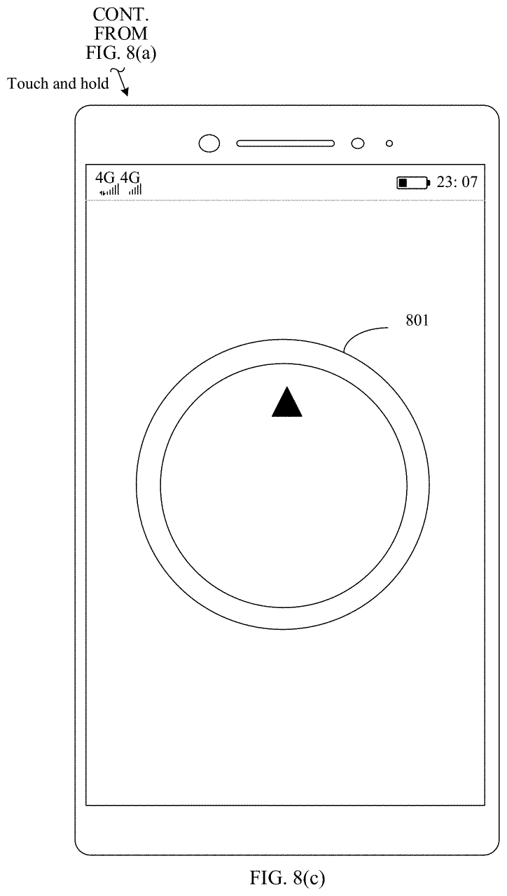

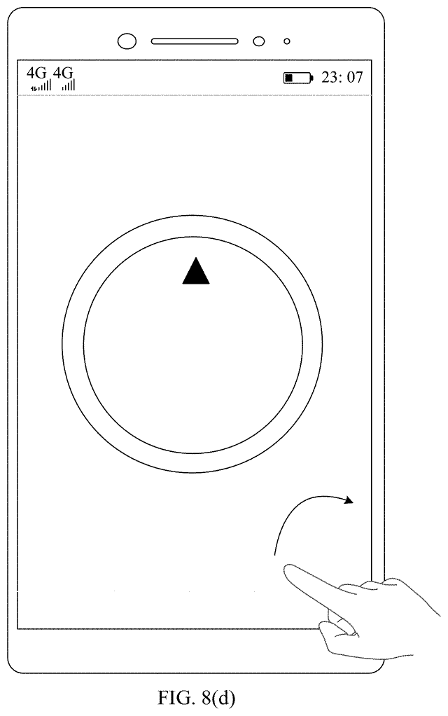

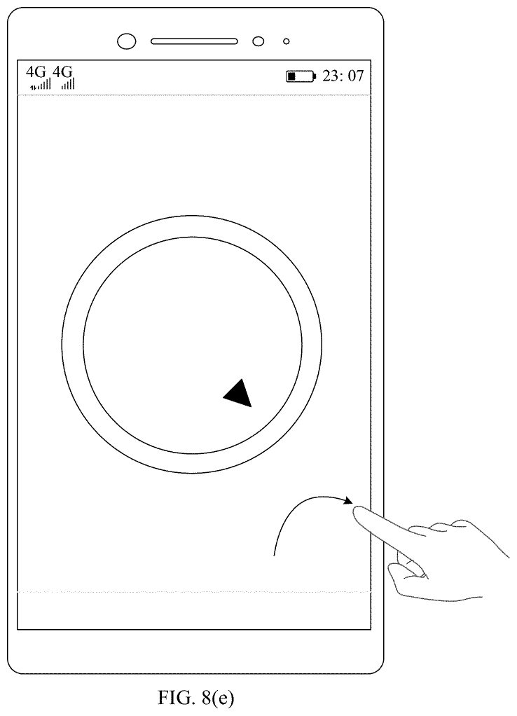

FIG. 8(a) to FIG. 8(e) show another group of GUIs of the mobile phone.

Refer to FIG. 8(a). The GUI is another display interface of the control panel of the mobile phone. After detecting an operation of sliding the bedroom lamp switch control right performed by the user on the display interface of the control panel, the mobile phone may display the GUI shown in FIG. 8(b). For example, after detecting the operation of sliding the control right performed by the user, the mobile phone may send an instruction to the cloud server, where the instruction is used to instruct to turn on the bedroom lamp. The cloud server may send the instruction to the bedroom lamp. After the instruction is received by the bedroom lamp, the bedroom lamp may be turned on.

After detecting an operation of touching and holding the bedroom lamp switch control performed by the user on the display interface of the control panel, the mobile phone may display the GUI shown in FIG. 8(c). Similarly, after detecting that the user touches and holds the bedroom lamp switch control, the mobile phone may send an instruction to the cloud server, to control the bedroom lamp to be turned on. The mobile phone may further display a color temperature adjustment bar 801 corresponding to the bedroom lamp.

In an embodiment, the color temperature adjustment bar of the bedroom lamp shown in FIG. 8(c) may be displayed after the user touches and holds the bedroom lamp switch control for duration longer than preset duration (for example, 2s). In this case, the finger of the user may remain on the screen, so that the screen of the mobile phone may keep displaying the color temperature adjustment bar of the bedroom lamp. Refer to in FIG. 8(d). The GUI is a display interface of the color temperature adjustment bar of the bedroom lamp. When the mobile phone detects an operation of sliding clockwise performed by the user on the screen, the mobile phone may control a color temperature value change of the color temperature adjustment bar.

Refer to in FIG. 8(e). The GUI is another display interface of the color temperature adjustment bar of the bedroom lamp.

In an embodiment of the application, such control may be further applied to an audio-type smart home product. The user may add shortcut operations of the smart speaker at home to the control panel, and tap the smart speaker switch control to complete an operation of turning on or turning off the speaker. The smart speaker switch control is touched and held, to switch to an interface of the volume adjustment bar. In this case, volume of the smart speaker can be adjusted when the hand slides the volume adjustment bar up and down without leaving the screen.

For another example, such control may be further applied to the smart home products such as the air conditioner or a fan. The user may add shortcut operations of the air conditioner at home to the control panel, and tap the smart air conditioner switch control to complete an operation of turning on or turning off the air conditioner. The smart air conditioner switch control is touched and held, to switch to a display interface of the temperature adjustment bar. In this case, temperature of the smart air conditioner can be quickly adjusted when the hand slides the temperature adjustment bar up and down without leaving the screen.

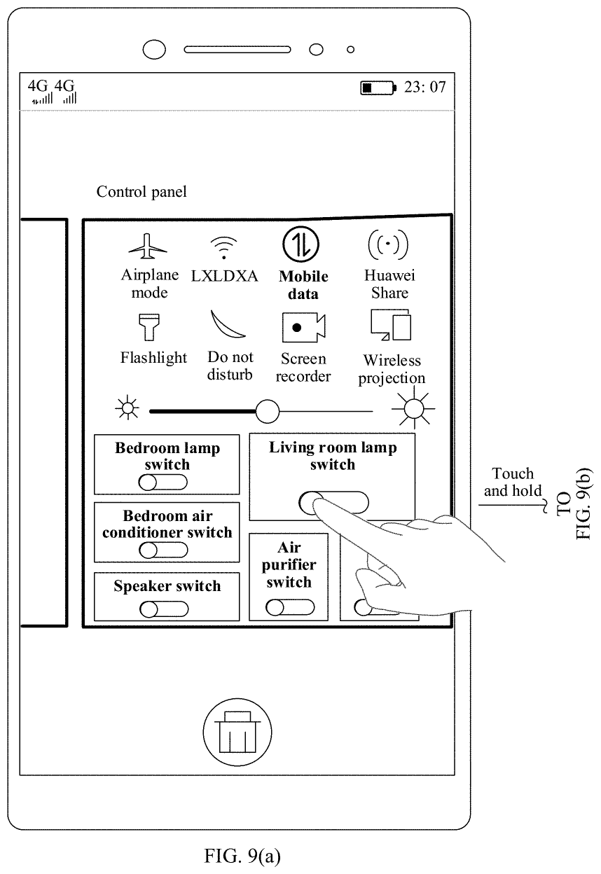

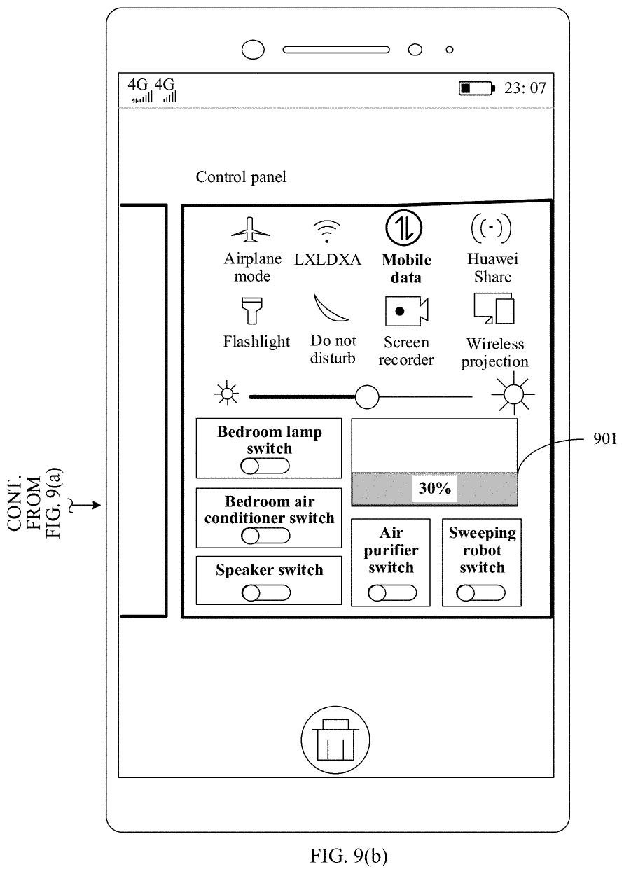

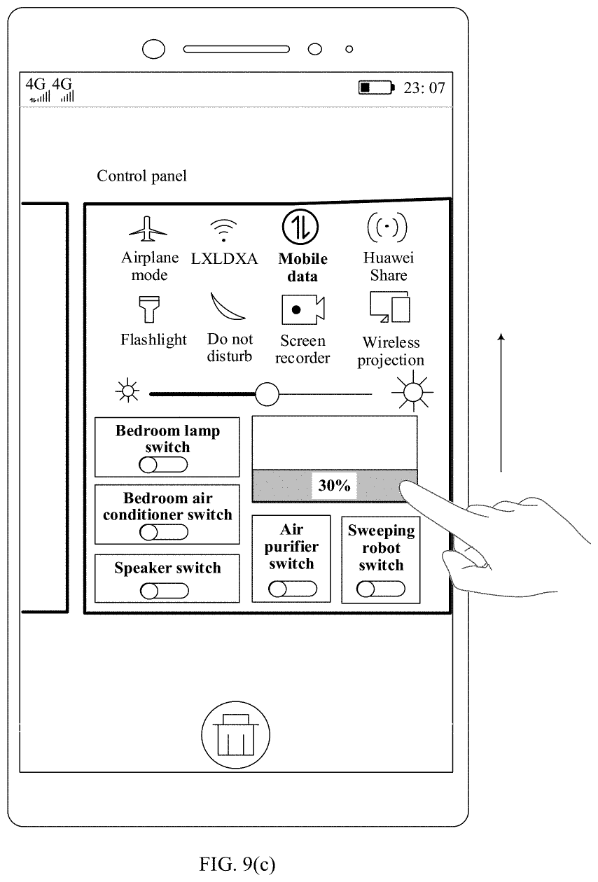

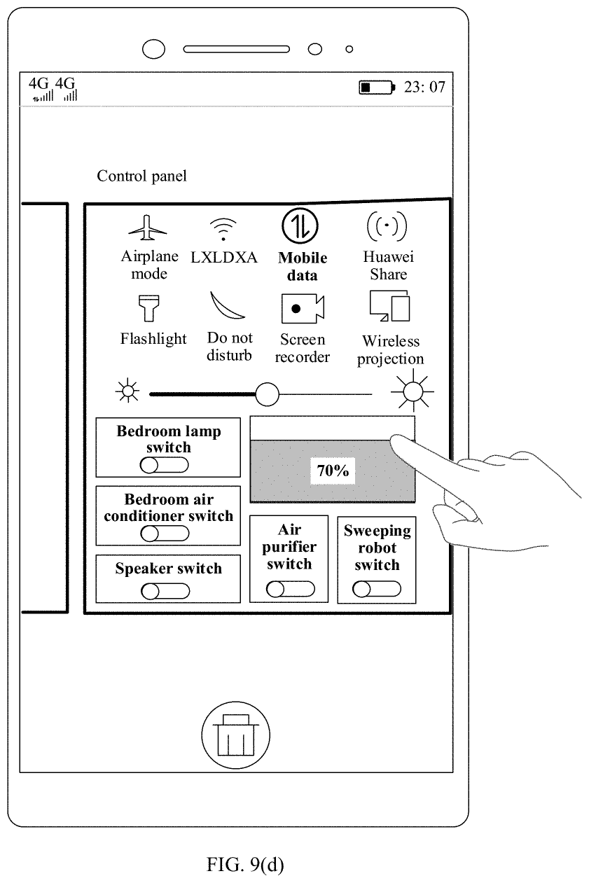

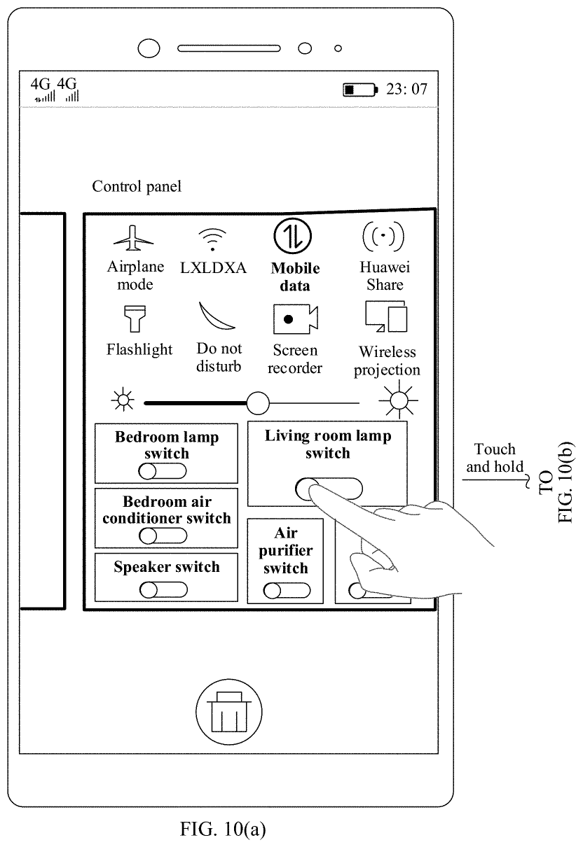

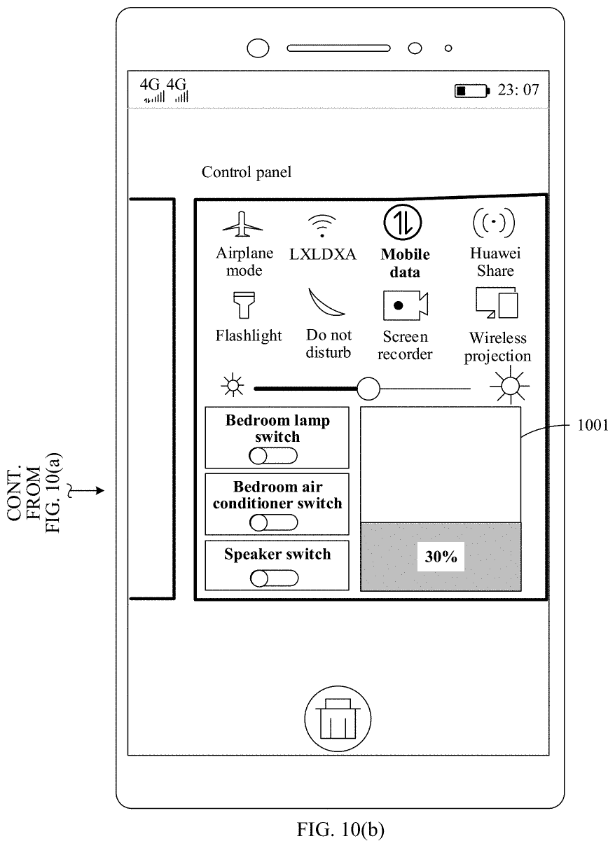

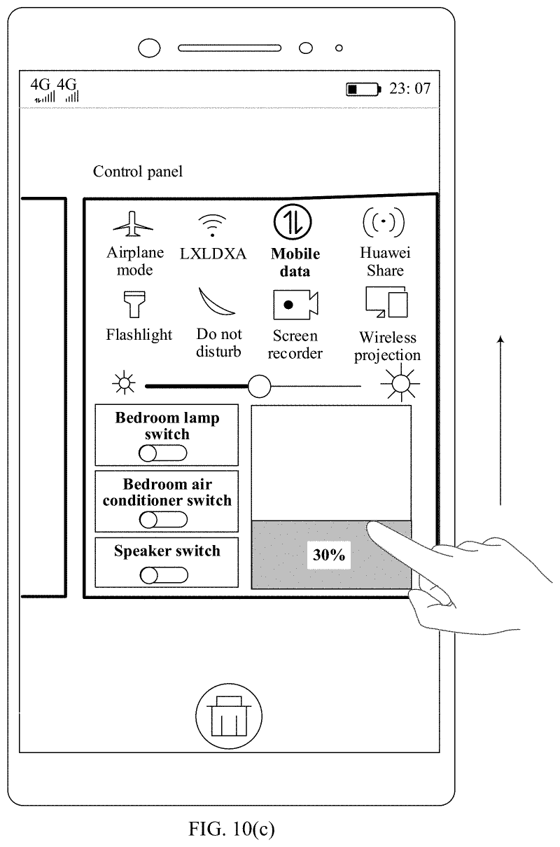

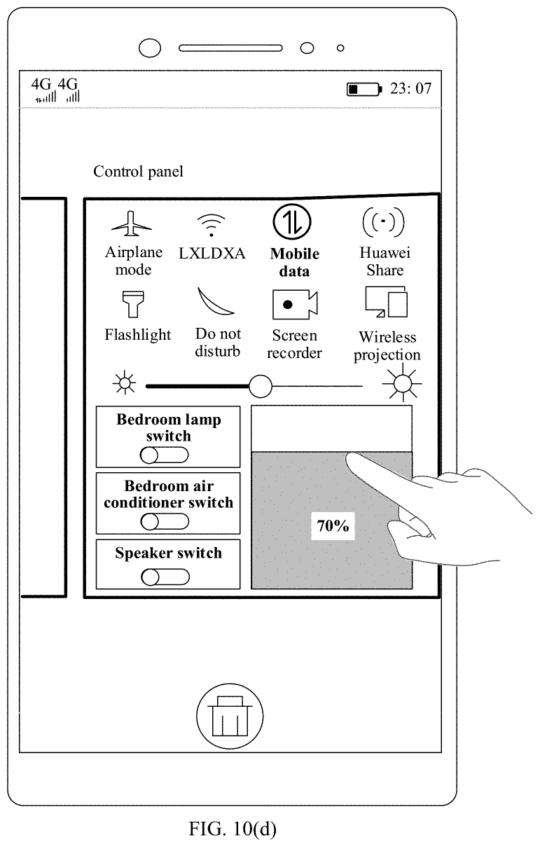

In an embodiment, the display interface after the switch control is touched and held may have other forms. Refer to GUIs shown in FIG. 9(a) to FIG. 9(d) and FIG. 10(a) to FIG. 10(d).

FIG. 9(a) to FIG. 9(d) show another group of GUIs of the mobile phone.

Refer to FIG. 9(a). The GUI is another display interface of the plurality of task cards and the control panel. After detecting the operation of touching and holding the living room lamp switch control performed by the user, the mobile phone may display the GUI shown in FIG. 9(b). Compared with FIG. 7(d), after detecting the operation of touching and holding the living room lamp switch control performed by the user, the mobile phone may not display the brightness adjustment bar of the living room lamp in a full screen, but directly display the brightness adjustment bar of the living room lamp in the fourth area 704 of the control panel. An original display area of the living room lamp switch control becomes a display area of the brightness adjustment bar of the living room lamp.

Refer to FIG. 9(c). After detecting an operation of sliding up performed by the user in the display area of the brightness adjustment bar of the living room lamp, the mobile phone may adjust the brightness value of the living room lamp.

Refer to in FIG. 9(d). The GUI is another display interface of the brightness adjustment bar of the living room lamp. The user may adjust the brightness value of the living room lamp to 70%, namely, the maximum brightness value.

It should be understood that, for a process in which the mobile phone adjusts the brightness value of the living room lamp by using the brightness adjustment bar of the living room lamp on the control panel, refer to the descriptions in the foregoing embodiments. For brevity, details are not described herein again.

Refer to FIG. 10(a). The GUI is another display interface of the plurality of task cards and the control panel. After detecting the operation of touching and holding the living room lamp switch control performed by the user, the mobile phone may display the GUI shown in FIG. 10(b). Compared with FIG. 7(d), after detecting the operation of touching and holding the living room lamp switch control performed by the user, the mobile phone may not display the brightness adjustment bar of the living room lamp in the full screen, but directly display the adjustment bar on a current display interface of the control panel. The original display area of the living room lamp switch control, an original display area of the air purifier switch control, and an original display area of the floor sweeping robot switch control all become the display area of the brightness adjustment bar of the living room lamp.

Refer to FIG. 10(c). After detecting the operation of sliding up performed by the user in the display area of the brightness adjustment bar of the living room lamp, the mobile phone may adjust the brightness value of the living room lamp.

Refer to FIG. 10(d). The GUI is another display interface of the brightness adjustment bar of the living room lamp. The user may adjust the brightness value of the living room lamp to 70%, namely, the maximum brightness value.

With reference to FIG. 7(a) to FIG. 9(d), the foregoing describes a process of setting the switch controls of the smart devices on the control panel and switching to the display interfaces of the adjustment bars by touching and holding the switch controls in an embodiment of the application. In addition, redirection entries to common applications such as Alarm, Calendar, a WeChat payment code, and an Alipay payment code may be further set on the control plane.

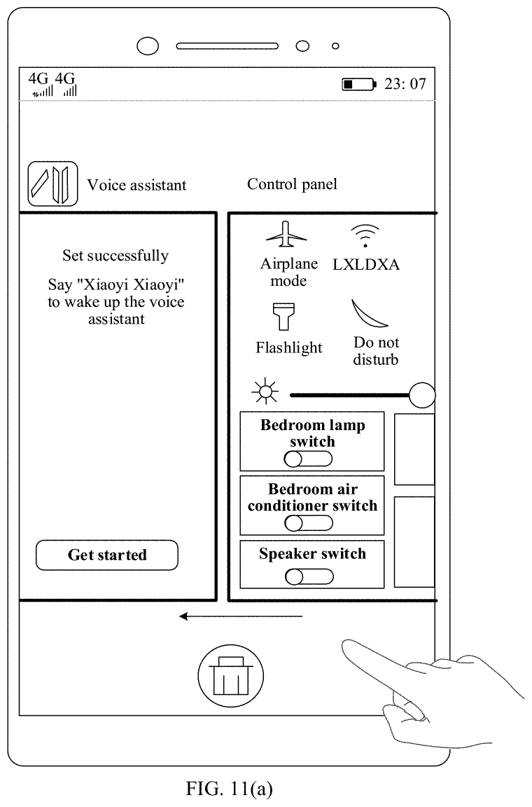

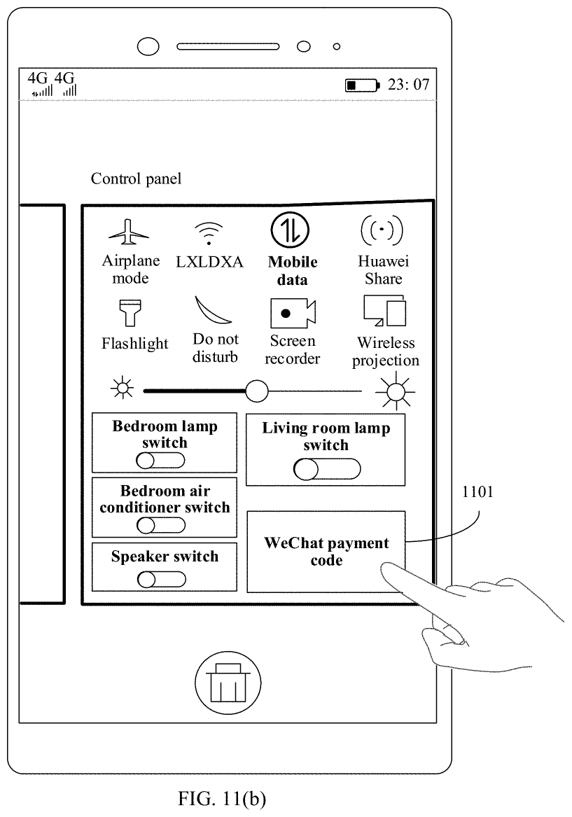

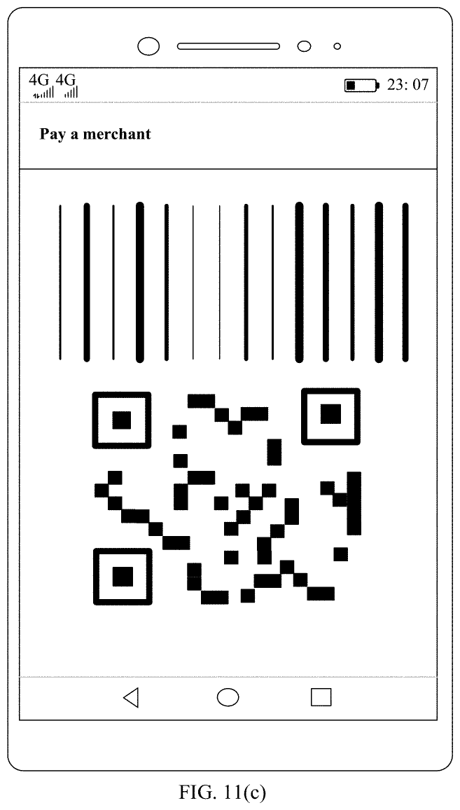

Refer to FIG. 11(a). A GUI is another display interface of the plurality of task cards and the control panel of the mobile phone. After detecting the operation of sliding left performed by the user on the display interface of the plurality of task cards and the control panel, the mobile phone may display the GUI shown in FIG. 11(b).

Refer to FIG. 11(b). A GUI is another display interface of the plurality of task cards and the control panel of the mobile phone. After detecting the operation of sliding left performed by the user on the screen, the mobile phone may display the complete control panel. Compared with the GUI shown in FIG. 3(c), in the GUI shown in FIG. 11(b), the functions on the control panel further include the bedroom lamp switch control, the bedroom air conditioner switch control, the speaker switch control, the living room lamp switch control, and a redirection entry 1101 to the WeChat payment code. After detecting an operation of tapping the redirection entry 1101 performed by the user, the mobile phone may display a GUI shown in FIG. 11(c).

Refer to FIG. 11(c). The GUI is a display interface of the WeChat payment code. The user may display the interface to a merchant to complete commodity amount payment.

In an embodiment, before displaying the interface of the WeChat payment code, the mobile phone may further prompt the user to perform user authentication, for example, fingerprint authentication, password authentication, facial recognition, or verification code authentication. After the user authentication of the mobile phone succeeds, the display interface of the WeChat payment code shown in FIG. 11(c) is displayed.

In an embodiment of the application, the entry to the plurality of task cards and the entry to the control panel are integrated. When the functions of the plurality of task cards are invoked, the interface of the control panel may be simultaneously displayed on the interface, and the redirection entries to some common applications may be added to the interface of the control panel, so that the user can start an application in a timely manner and perform a corresponding operation. Because there are more mobile phone applications currently, the redirection entries to some common applications are added to the interface of the control panel, so that the user can quickly start the applications, and user experience is improved.

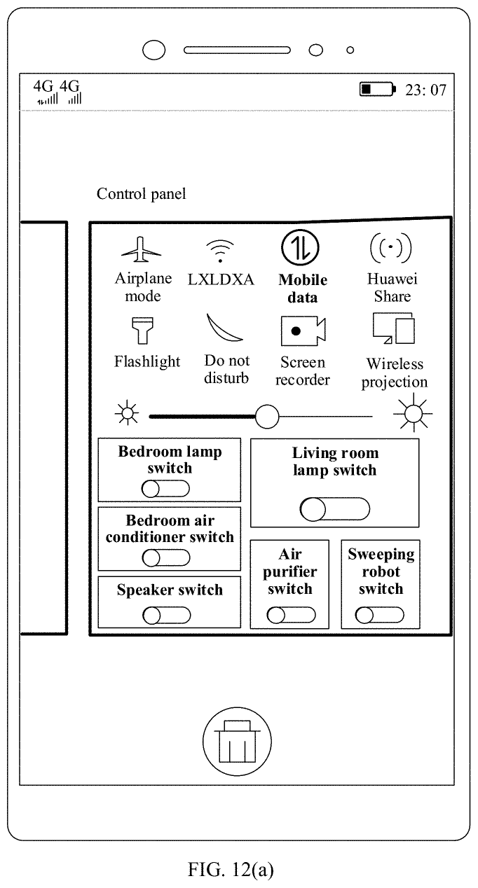

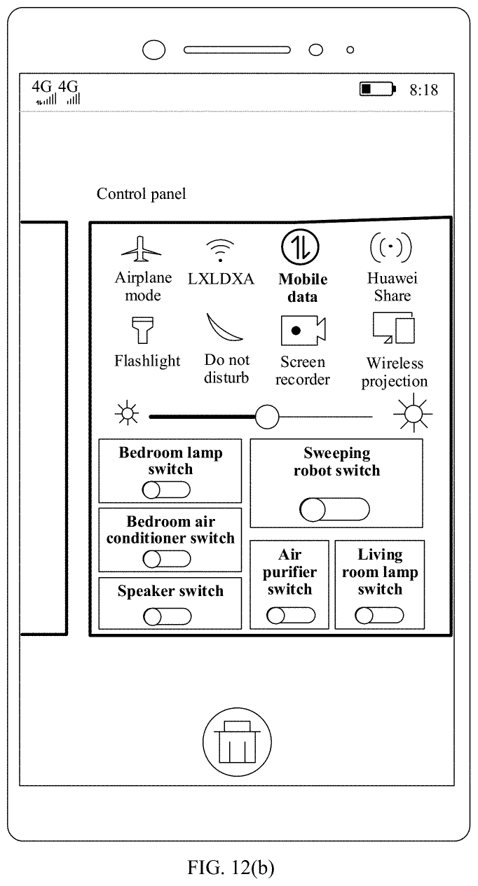

In an embodiment, the switch controls or the redirection entries to the applications are merely presentation forms on the control panel, and visual presentation forms of the switch controls or the redirection entries may be variable, including shapes and arrangements of the switch controls or the redirection entries. For example, to facilitate an operation performed by the user, the shapes, sizes, and an arrangement order of the redirection entries may vary based on an order of operation frequencies at which the user uses the switch controls and the redirection entries. In an embodiment shown in FIG. 12(a), an area of a display area of the living room lamp switch control>areas of display areas of the air purifier switch control and the floor sweeping robot switch control>areas of display areas of the bedroom lamp switch control, the bedroom air conditioner switch control, and the smart speaker switch control. This indicates that the user may operate functions related to the living room lamp most frequently, functions related to the air purifier and the floor sweeping robot at a second frequency, and functions related to the bedroom lamp, the bedroom air conditioner, and the smart speaker least frequently. A usage frequency may be determined by a developer based on a market research result at beginning of a design of a mobile phone operating system. Alternatively, the shapes and the sizes of the function controls each are the same before delivery. Alternatively, the usage frequency may be set by the user by using a setting function of the control panel. The mobile phone operating system changes positions of these switch controls when the user uses the switch controls later.

Refer to FIG. 12(b). After determining that a frequency at which the user uses the floor sweeping robot is higher than a frequency at which the user uses the living room lamp, the mobile phone may automatically exchange the position of the floor sweeping robot switch control and the position of the living room lamp switch control.

In an embodiment, the mobile phone may count a quantity of times that the user controls, by using the control panel, the bedroom lamp, the bedroom air conditioner, the smart speaker, the floor sweeping robot, the air purifier, and the living room lamp within preset duration (for example, a week or a month). If it is determined that frequencies at which the user uses the foregoing smart devices is ranked from high to low as the floor sweeping robot, the air purifier, the living room lamp, the bedroom lamp, the bedroom air conditioner, and the smart speaker, the mobile phone may automatically change the display position of the floor sweeping robot switch control and the display position of the living room lamp switch control on the control panel.

In an embodiment, the control panel includes the living room lamp switch control, the bedroom lamp switch control, and a redirection entry to a first application (for example, the WeChat payment code or the Alipay payment code), the area of the display area of the living room lamp switch control is greater than the area of the display area of the bedroom lamp switch control, and the area of the display area of the bedroom lamp switch control is greater than an area of a display area of the redirection entry to the first application. After a period of time, the electronic device determines that a frequency at which the user uses the redirection entry to the first application is greater than the frequency at which the user uses the bedroom lamp switch control, and the frequency at which the user uses the bedroom lamp switch control is greater than the frequency at which the user uses the living room lamp switch control. In this case, the electronic device may automatically exchange the display position of the living room lamp switch control and a display position of the redirection entry to the first application on the control panel. In this case, after starting the control panel next time, the user may find the redirection entry to the first application at a location with a relatively large display area, so that the user starts the first application in a timely manner and performs a corresponding operation.

In an embodiment of the application, the mobile phone may update a location of a response switch control or a location of a redirection entry to an application on the control panel based on a frequency at which the user controls a smart device or enters the application by using the control panel. An area of a display area of a switch control of a smart device frequently used by the user or an area of a display area of an application frequently used by the user is larger, so that after starting the control panel, the user finds the corresponding switch control or a redirection entry to the application in a timely manner, thereby improving user experience when the user uses the smart device or the application.

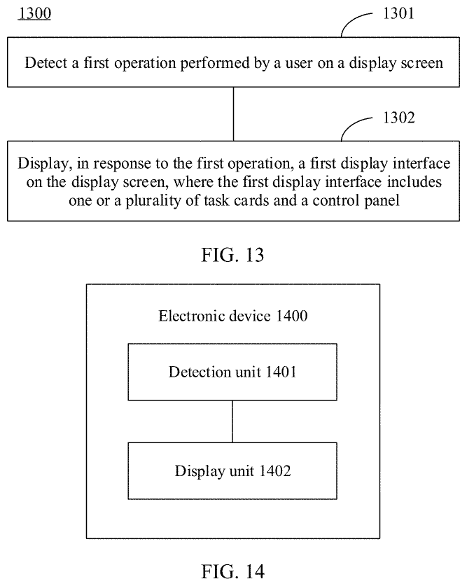

With reference to the foregoing embodiments and the related accompanying drawings, an embodiment of this application provides a display method. The method may be implemented by the electronic device having the display screen (for example, the mobile phone or the tablet computer) in FIG. 1 and FIG. 2. As shown in FIG. 13, the method may include the following operations.

S1301: The electronic device detects a first operation performed by a user on the display screen.

In an embodiment, the first operation is an operation of switching to an interface of a plurality of task cards in the existing electronic device.

For example, the first operation is the operation of tapping the control 301 performed by the user in FIG. 3(a).

For example, the first operation is an operation of sliding from the lower part of the screen to the upper part of the screen performed by a finger of the user.

For example, the first operation is an operation of double-tapping a Home key performed by the user.

S1302: The electronic device displays, in response to the first operation, a first display interface on the display screen, where the first display interface includes one or the plurality of task cards and a control panel, and the one or each of the plurality of task cards corresponds to an application.

For example, as shown in FIG. 3(b), after detecting the operation of tapping the control 301 performed by the user, the mobile phone may display the display interface of the one or the plurality of task cards and the control panel.

For example, as shown in FIG. 5(a), after detecting the operation of tapping the control 301 performed by the user, the mobile phone may display the display interface of the one or the plurality of task cards and the control panel.

It should be understood that, in an embodiment of the application, after detecting the operation of tapping the control 301 performed by the user, the mobile phone may alternatively directly display the GUI shown in FIG. 3(c) (display the complete control plane and a part of a task card). After detecting the operation of sliding right performed by the user on the display interface shown in FIG. 3(c), the mobile phone may display the one or the plurality of task cards.

In one embodiment, the control panel includes switch controls or adjustment bars of parameter values that are of one or more smart devices.

For example, refer to FIG. 7(b). The bedroom lamp switch control may be displayed in the area 701 on the control panel, the bedroom air conditioner switch control may be displayed in the area 702, the speaker switch control may be displayed in the area 703, and the living room lamp switch control may be displayed on the area 704, and the like.

In an embodiment, the method 1300 further includes: The electronic device detects a second operation performed by the user in a first area on the control panel, where the first area includes a switch control of a first smart device, and the one or more smart devices include the first smart device. The electronic device displays, in response to the second operation, an adjustment bar of a first parameter value of the first smart device in the first area.

For example, the first area may be the display area 704 of the living room lamp switch control in FIG. 9(b), and the second operation may be an operation of touching and holding performed by the user. After detecting the operation of touching and holding performed by the user, the mobile phone may display the brightness adjustment bar 901 of the living room lamp in the area 704.

In an embodiment, the method 1300 further includes: The electronic device detects a second operation performed by the user in a first area on the control panel, where the first area includes a switch control of a first smart device, and the one or more smart devices include the first smart device. The electronic device displays, in response to the second operation, an adjustment bar of a first parameter value of the first smart device in an entire display area of the control panel, or displays an adjustment bar of a first parameter value of the first smart device on the entire display screen.

For example, the first area may be the display area 704 in FIG. 7(b), and the second operation may be the operation of touching and holding performed by the user. After detecting the operation of touching and holding performed by the user, the mobile phone may display the brightness adjustment bar of the living room lamp on the entire display screen of the mobile phone.

In an embodiment, a second area of the control panel includes a redirection entry to a first application. The method 1300 further includes: The electronic device detects a third operation performed by the user in the second area. The electronic device displays, in response to the third operation, a display interface of the first application on the display screen.

For example, as shown in FIG. 11(b), the redirection entry 1101 to the WeChat payment code may be displayed on the control panel. When detecting the operation of tapping the redirection entry 1101 to the WeChat payment code performed by the user, the mobile phone may display the display interface of the WeChat payment code shown in FIG. 11(c).

In an embodiment, a third area of the control panel includes first information; and the first information is a switch control of a second smart device, an adjustment bar of a second parameter value, or a redirection entry to a second application. A fourth area of the control panel includes second information; the second information is a switch control of a third smart device, an adjustment bar of a third parameter value, or a redirection entry to a third application. A display area of the third area is greater than a display area of the fourth area. The method 1300 further includes: automatically displaying the second information in the third area and displaying the first information in the fourth area when it is detected within preset time that a frequency at which the user uses the second information is greater than a frequency at which the user uses the first information.

For example, the third area is the area 704, and the fourth area is the area 706. As shown in FIG. 12(a), the living room lamp switch control is displayed in the third area, and the floor sweeping robot switch control is displayed in the fourth area. After a period of time, the mobile phone determines that within the preset duration (for example, a week or a month), a frequency at which the user uses the floor sweeping robot is greater than a frequency at which the user uses the living room lamp. In this case, the mobile phone may automatically exchange content displayed in the third area and the fourth area. As shown in FIG. 12(b), the mobile phone may automatically display the floor sweeping robot switch control in the area 704 after the preset duration, and display the living room lamp switch control in the area 706.

It may be understood that, to implement the foregoing functions, the electronic device includes corresponding hardware and/or software modules for performing the functions. With reference to algorithm operations of each example described in embodiments disclosed in this specification, this application can be implemented in a form of hardware or a combination of hardware and computer software. Whether a function is performed by hardware or hardware driven by computer software depends on particular applications and design constraints of the technical solutions. One of ordinary skilled in the art may use different methods to implement the described functions for each particular application with reference to embodiments, but it should not be considered that the implementation goes beyond the scope of this application.

In embodiments, the electronic device may be divided into function modules based on the examples in the foregoing method. For example, each function module corresponding to each function may be obtained through division, or two or more functions may be integrated into one processing module. The integrated module may be implemented in a form of hardware. It should be noted that, in the embodiments, division into modules is an example, and is merely logical function division. In an embodiment, another division manner may be used.

When each function module is obtained through division corresponding to each function, FIG. 14 is a possible schematic composition diagram of an electronic device 1400 in the foregoing embodiments. As shown in FIG. 14, the electronic device 1400 may include a detection unit 1401 and a display unit 1402.

The detection unit 1401 may be configured to support the electronic device 1400 in performing the foregoing operation S1301, and/or is configured in another process of the technology described in this specification.

The display unit 1402 may be configured to support the electronic device 1400 in performing the foregoing operation S1302, and/or is configured in another process of the technology described in this specification.

It should be noted that all related content of the operations in the foregoing method embodiments may be cited in function descriptions of corresponding function modules. Details are not described herein again.

The electronic device provided in an embodiment is configured to perform the display method. Effects that are the same as those of the foregoing implementation method can be achieved.

When an integrated unit is used, the electronic device may include a processing module, a storage module, and a communication module. The processing module may be configured to control and manage actions of the electronic device, for example, may be configured to support the electronic device in performing the operations performed by the detection unit 1401 and the display unit 1402. The storage module may be configured to support the electronic device to store program code, data, and the like. The communication module may be configured to support communication between the electronic device and another device.

The processing module may be a processor or a controller. The processor may implement or execute various example logical blocks, modules, and circuits described with reference to content disclosed in this application. Alternatively, the processor may be a combination of processors implementing a computing function, for example, a combination of one or more microprocessors, or a combination of digital signal processor (DSP) and a microprocessor. The storage module may be a memory. The communication module may be a device, for example, a radio frequency circuit, a Bluetooth chip, or a Wi-Fi chip, that interacts with another electronic device.

In an embodiment, when the processing module is the processor and the storage module is the memory, the electronic device in an embodiment may be a device having the structure shown in FIG. 1.

An embodiment further provides a computer storage medium. The computer storage medium stores computer instructions; and when the computer instructions are run on an electronic device, the electronic device is enabled to perform the foregoing related method operations, to implement the display method in the foregoing embodiments.

An embodiment further provides a computer program product. When the computer program product runs on a computer, the computer is enabled to perform the foregoing related operations, to implement the display method in the foregoing embodiments.

In addition, an embodiment of this application further provides an apparatus. The apparatus may be a chip, a component, or a module. The apparatus may include a processor and a memory that are connected to each other. The memory is configured to store computer-executable instructions. When the apparatus runs, the processor may execute the computer-executable instructions stored in the memory, to enable the chip to perform the display method in the foregoing method embodiments.

The electronic device, the computer storage medium, the computer program product, or the chip provided in embodiments is configured to perform the corresponding method provided above. Therefore, for beneficial effects that can be achieved, refer to beneficial effects in the corresponding method provided above. Details are not described herein again.

Based on descriptions of the foregoing implementations, one of ordinary skilled in the art understands that, for purpose of convenient and brief description, division into the foregoing function modules is used as an example for illustration. In actual application, the foregoing functions may be allocated to different modules and implemented based on a requirement, that is, an inner structure of an apparatus is divided into different function modules to implement all or some of the functions described above.

In the several embodiments provided in this application, it should be understood that the disclosed apparatus and method may be implemented in other manners. For example, the described apparatus embodiment is merely an example. For example, division into the modules or units is merely logical function division and may be other division in an embodiment. For example, a plurality of units or components may be combined or integrated into another apparatus, or some features may be ignored or not performed. In addition, the displayed or discussed mutual coupling or direct coupling or communication connection may be implemented through some interfaces. Indirect coupling or communication connection between the apparatuses or units may be implemented in electrical, mechanical, or other forms.

The units described as separate parts may or may not be physically separate, and parts displayed as units may be one or more physical units, may be located in one place, or may be distributed on different places. Some or all of the units may be selected based on an actual requirement to achieve objectives of the solutions of embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in the form of a software product. The software product is stored in a storage medium and includes several instructions for instructing a device (which may be a single-chip microcomputer, a chip or the like) or a processor to perform all or some of the steps of the methods described in embodiments of this application. The foregoing storage medium includes any medium that can store program code, for example, a USB flash drive, a removable hard disk, a read-only memory (ROM), a random access memory (RAM), a magnetic disk, or an optical disc.

The foregoing descriptions are merely implementations of the application, but are not intended to limit the protection scope of this application. Any variation or replacement readily figured out by one or ordinary skilled in the art within the technical scope disclosed in this application shall fall within the protection scope of this application. Therefore, the protection scope of this application shall be subject to the protection scope of the claims.

What is claimed is:

1. A display method, comprising:
detecting, by an electronic device, a first operation performed by a user on a display screen of the electronic device; and
displaying, by the electronic device in response to the first operation, a first display interface on the display screen, wherein the first display interface comprises a control panel and one or more task cards corresponding to an application.

2. The method according to claim 1, wherein the control panel comprises switch controls or adjustment bars of parameter values of one or more smart devices, and/or redirection entries to one or more applications.

3. The method according to claim 2, wherein the one or more smart devices comprise a first smart device, wherein a first area of the control panel comprises a switch control of the first smart device; and wherein the method further comprises:
detecting, by the electronic device, a second operation performed by the user in the first area comprising the switch control of the first smart device; and
displaying, by the electronic device in response to the second operation, an adjustment bar of a first parameter value of the first smart device in the first area.

4. The method according to claim 2, wherein the one or more smart devices comprise the first smart device, wherein a first area of the control panel comprises a switch control of the first smart device; and wherein the method further comprises:
detecting, by the electronic device, a second operation performed by the user in the first area comprising the switch control of the first smart device; and
displaying, by the electronic device in response to the second operation, an adjustment bar of a first parameter value of the first smart device in an entire display area of the control panel, or displaying an adjustment bar of a first parameter value on the entire display screen.

5. The method according to claim 2, wherein the one or more applications comprise the first application, wherein a second area of the control panel comprises a redirection entry to the first application; and wherein the method further comprises:
detecting, by the electronic device, a third operation performed by the user in the second area; and
displaying, by the electronic device in response to the third operation, a display interface of the first application on the display screen.

6. The method according to claim 2, wherein a third area of the control panel comprises first information that is a switch control of a second smart device, an adjustment bar of a second parameter value of the second smart device, or a redirection entry to a second application; wherein a fourth area of the control panel comprises second information that is a switch control of a third smart device, an adjustment bar of a third parameter value of the third smart device, or a redirection entry to a third application; wherein a display area of the third area is greater than a display area of the fourth area, wherein the one or more smart devices comprise the second smart device and the third smart device, and wherein the one or more applications comprise the second application and the third application; and wherein the method further comprises:
automatically displaying the second information in the third area and displaying the first information in the fourth area when it is detected within preset time that a frequency at which the user uses the second information is greater than a frequency at which the user uses the first information.

7. The method according to claim 2, wherein the first display interface displays the control panel and a first task card corresponding to an application started before the electronic device detects the first operation.

8. An electronic device, comprising:
a display screen;
one or more sensors
a processor; and
a memory coupled to the processor to store instructions, which when executed by the processor, cause the electronic device to perform operations, the operations comprising:
detecting a first operation performed by a user on the display screen; and
displaying, in response to the first operation, a first display interface on the display screen, wherein the first display interface comprises a control panel and one or more task cards corresponding to an application.

9. The electronic device according to claim 8, wherein the control panel comprises switch controls or adjustment bars of parameter values of one or more smart devices, and/or redirection entries to one or more applications.

10. The electronic device according to claim 9, wherein the one or more smart devices comprise the first smart device, wherein a first area of the control panel comprises a switch control of the first smart device; and wherein the operations further comprise:
detecting a second operation performed by the user in the first area comprising the switch control of the first smart device; and
displaying, in response to the second operation, an adjustment bar of a first parameter value of the first smart device in the first area.

11. The electronic device according to claim 9, wherein the one or more smart devices comprise the first smart device, wherein a first area of the control panel comprises a switch control of the first smart device; and wherein the operations further comprise:
detecting a second operation performed by the user in the first area comprising the switch control of the first smart device; and
displaying, in response to the second operation, an adjustment bar of a first parameter value of the first smart device in an entire display area of the control panel, or displaying an adjustment bar of a first parameter value on the entire display screen.

12. The electronic device according to claim 9, wherein the one or more applications comprise the first application, wherein a second area of the control panel comprises a redirection entry to the first application; and wherein the operations further comprise:
detecting a third operation performed by the user in the second area; and
displaying, in response to the third operation, a display interface of the first application on the display screen.

13. The electronic device according to claim 9, wherein a third area of the control panel comprises first information that is a switch control of a second smart device, an adjustment bar of a second parameter value of the second smart device, or a redirection entry to a second application; a fourth area of the control panel comprises second information that is a switch control of a third smart device, an adjustment bar of a third parameter value of the third smart device, or a redirection entry to a third application; wherein a display area of the third area is greater than a display area of the fourth area, wherein the one or more smart devices comprise the second smart device and the third smart device, and wherein the one or more applications comprise the second application and the third application; and wherein the electronic device is further configured to:
automatically display the second information in the third area and displaying the first information in the fourth area when it is detected within preset time that a frequency at which the user uses the second information is greater than a frequency at which the user uses the first information.

14. The electronic device according to claim 8, wherein the first display interface displays the control panel and a first task card corresponding to an application started before the electronic device detects the first operation.

15. A non-transitory machine-readable storage medium having instructions stored therein, which when executed by a processor, cause the processor to perform operations, the operations comprising:
detecting a first operation performed by a user on a display screen; and
displaying, in response to the first operation, a first display interface on the display screen, wherein the first display interface comprises a control panel and one or more task cards corresponding to an application.

16. The machine-readable medium according to claim 15, wherein the control panel comprises switch controls or adjustment bars of parameter values of one or more smart devices, and/or redirection entries to one or more applications.

17. The machine-readable medium according to claim 16, wherein the one or more smart devices comprise a first smart device, wherein a first area of the control panel comprises a switch control of the first smart device; and wherein the method further comprises:
detecting a second operation performed by the user in the first area comprising the switch control of the first smart device; and
displaying, in response to the second operation, an adjustment bar of a first parameter value of the first smart device in the first area.

18. The machine-readable medium according to claim 16, wherein the one or more smart devices comprise the first smart device, wherein a first area of the control panel comprises a switch control of the first smart device; and wherein the method further comprises:
detecting a second operation performed by the user in the first area comprising the switch control of the first smart device; and
displaying, in response to the second operation, an adjustment bar of a first parameter value of the first smart device in an entire display area of the control panel, or displaying an adjustment bar of a first parameter value on the entire display screen.

19. The machine-readable medium according to claim 16, wherein the one or more applications comprise the first application, wherein a second area of the control panel comprises a redirection entry to the first application; and wherein the method further comprises:
detecting a third operation performed by the user in the second area; and
displaying, in response to the third operation, a display interface of the first application on the display screen.

20. The machine-readable medium according to claim 16, wherein a third area of the control panel comprises first information that is a switch control of a second smart device, an adjustment bar of a second parameter value of the second smart device, or a redirection entry to a second application; wherein a fourth area of the control panel comprises second information that is a switch control of a third smart device, an adjustment bar of a third parameter value of the third smart device, or a redirection entry to a third application; wherein a display area of the third area is greater than a display area of the fourth area, wherein the one or more smart devices comprise the second smart device and the third smart device, and wherein the one or more applications comprise the second application and the third application; and wherein the method further comprises:
automatically displaying the second information in the third area and displaying the first information in the fourth area when it is detected within preset time that a frequency at which the user uses the second information is greater than a frequency at which the user uses the first information.
